(19) United States
(12) Patent Application Publication
(10) Pub. No.: US 2002/0025184 A1
(43) Pub. Date: Feb. 28, 2002

(54) Electrophotographic cartridge image-forming method and image-forming apparatus

(75) Inventors: Tomoko Ishikawa, Kanagawa (JP); Osamu Ando, Kanagawa (JP); Mamoru Nozomi, Kanagawa (JP); Akiteru Fujii, Kanagawa (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Mitsubishi Chemical Corporation, Chiyoda-ku (JP)

(21) Appl. No.: 09/829,930

(22) Filed: Apr. 11, 2001

(30) Foreign Application Priority Data
Apr. 12, 2000 (JP) 2000-110420

(51) Int. Cl. G03G 15/08

(52) U.S. Cl. 399/111; 430/110.4; 430/137.14; 430/78; 399/159; 430/137.17; 430/59.6; 430/45; 430/46

(57) ABSTRACT

An image-forming apparatus comprising at least a photoreceptor, a toner and an exposure device, wherein the photoreceptor has a photosensitive layer containing oxytitanium phthalocyanine having a distinct diffraction peak at a Bragg angle (2θ±0.2) of 27.3° in the X-ray diffraction by CuKα-ray, and the toner has a volume average particle diameter (Dv) of from 3 to 8 μm and satisfies a relation of 1.0≦Dv/Dn≦1.3 where Dv is the volume average particle diameter and Dn is the number average particle diameter.

The present invention relates to an image-forming method and an image-forming apparatus. More particularly, it relates to an image-forming method and apparatus useful for printers or electrophotographic copying machines.

Along with widespread use of copying machines and printers employing electrophotography, the demand for high definition images has increased in recent years.

In order to obtain high definition images, particularly in order to improve the gradation or resolution, it is conceivable to increase the number of dots at the time of image exposure. For this purpose, the beam diameter is reduced, and the number of output pulses is increased. However, in such high density recording, the time required for exposure for one dot tends to be short. In such a case, with a conventional photoreceptor, the photoresponsivity is inadequate, whereby reproducibility of one dot is poor, and accordingly, it is not possible to improve the gradation or resolution. Further, as a method to solve such a problem, it is conceivable to increase the light energy itself, but this will bring about a problem such as fatigue by light of the photosensitive layer.

As a method to solve the above problems, JP-A-3-37678 discloses a method wherein a crystal type oxytitanyl phthalocyanine showing a strong peak at a Bragg angle 2θ of 27.2±0.2° in the X-ray diffraction to CuKα characteristic X-rays (wavelength: 1.541 Å), is used as a photoconductive material of the photosensitive layer, and it is shown that by using this oxytitanyl phthalocyanine, a photoreceptor showing high sensitivity, high γ characteristics and adequate photoresponsivity, can be realized, and when this photoreceptor is employed, adequate dot reproducibility can be realized even if the exposure time for each dot is short in high density recording.

The same publication discloses combined use of a toner having a small particle diameter i.e. an average particle diameter of at most 8 μm, but in reality, the above-mentioned problems can not adequately be solved simply by the fact that the toner has a small particle diameter. Namely, even with a small diameter toner, depending upon the particle diameter or the particle size distribution of the toner, the flowability of the toner may deteriorate, or a toner containing a colorant or a charge controlling agent non-uniformly, may be present as mixed, whereby adhesion on a latent image tends to be non-uniform, and it is thereby impossible to accurately reproduce the latent image.

The present invention has been made to solve the above problems of the prior art. Namely, it is an object of the present invention to provide a development method whereby it is possible to obtain an image excellent in fine line reproducibility or gradation.

The present inventors have conducted an extensive study in view of the above problems and as a result, have found it possible to solve the above problems by a combination of a certain specific electrophotographic photoreceptor and a certain specific toner. The present invention has been accomplished on the basis of such a discovery.

Namely, the present invention provides an image-forming apparatus comprising at least a photoreceptor, a toner and an exposure device, wherein the photoreceptor has a photosensitive layer having a charge generation layer containing oxytitanium phthalocyanine having a distinct diffraction peak at a Bragg angle (2θ±0.2) of 27.3° in the X-ray diffraction by CuKα-ray and a charge transport layer laminated, and the toner has a volume average particle diameter (Dv) of from 3 to 8 μm and satisfies a relation of 1.0≦Dv/Dn≦1.3 where Dv is the volume average particle diameter and Dn is the number average particle diameter.

In another aspect, the present invention provides an image-forming method employing an image-forming apparatus comprising at least a photoreceptor, an exposure device and a toner, which comprises subjecting a photoreceptor having a photosensitive layer having a charge generation layer containing oxytitanium phthalocyanine having a distinct diffraction peak at a Bragg angle (2θ±0.2) of 27.3° in the X-ray diffraction by CuKα-ray and a charge transport layer laminated, to digital image exposure by said exposure device, to form an electrostatic latent image on the photoreceptor, and developing the electrostatic latent image, wherein a toner having a volume average particle diameter (Dv) of from 3 to 8 μm and satisfying a relation of 1.0≦Dv/Dn≦1.3 where Dv is the volume average particle diameter and Dn is the number average particle diameter, is used for the development.

In still another aspect, the present invention provides an electrophotographic cartridge accommodating both a toner having a volume average particle diameter (Dv) of from 3 to 8 μm and satisfying a relation of 1.0≦Dv/Dn≦1.3 where Dv is the volume average particle diameter and Dn is the number average particle diameter and a photoreceptor having a charge generation layer containing oxytitanium phthalocyanine having a distinct diffraction peak at a Bragg angle (2θ±0.2) of 27.3° in the X-ray diffraction by CuKα-ray and a charge transport layer laminated.

In the accompanying drawings:

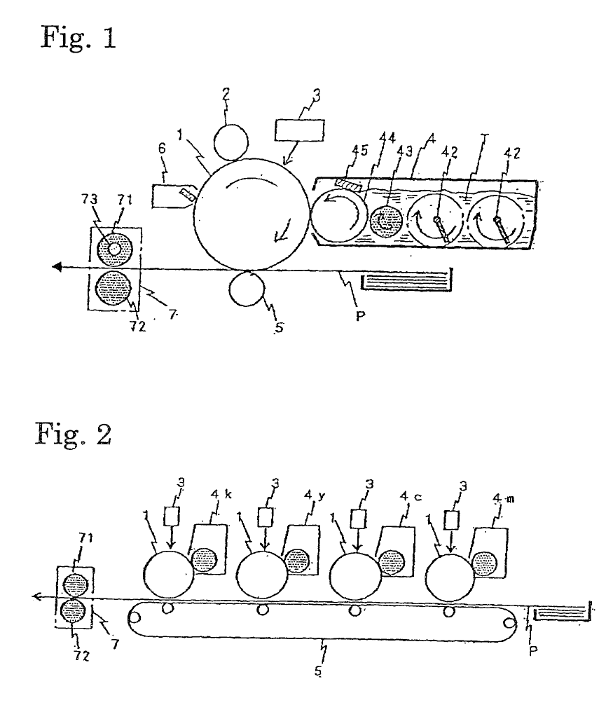

FIG. 1 is a schematic view of an embodiment of the image-forming apparatus used in the present invention.

FIG. 2 is a schematic view showing the main constituting parts of one embodiment of a tandem type full color image-forming apparatus to be used in the present invention.

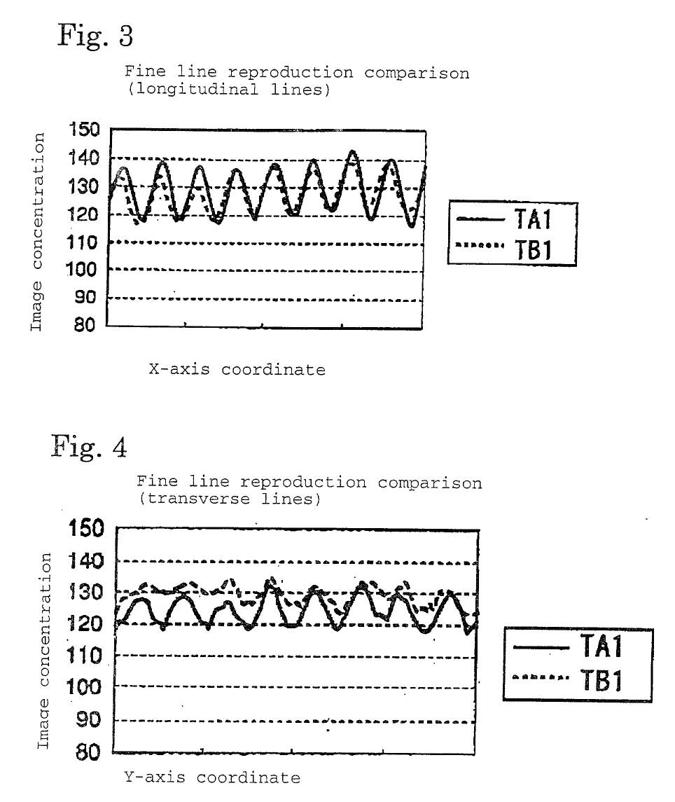

FIG. 3 is a graph showing the results of image analyses of fine line images drawn in a longitudinal direction in Example A1 and Comparative Example B1.

FIG. 4 is a graph showing the results of image analyses of fine line images drawn in a transverse direction in Example A1 and Comparative Example B1.

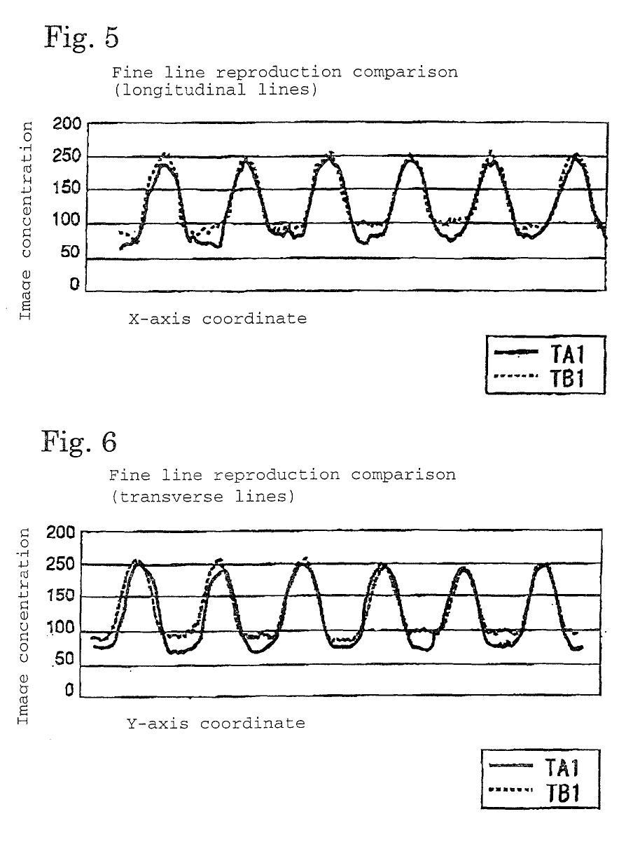

FIG. 5 is a graph showing the results of an image analysis of a fine line image drawn in a longitudinal direction in Reference Example.

FIG. 6 is a graph showing the results of an image analysis of a fine line image drawn in a transverse direction in Reference Example.

Now, the image-forming method of the present invention and the image-forming apparatus employed in the method, will be described with respect to an electrophotographic recording apparatus using a non-magnetic one component system toner, as an embodiment of a full color image-forming method. However, it should be understood that the present invention is by no means restricted to such an embodiment.

FIG. 1 is a schematic view of the construction of the main parts of one embodiment of an electrophotographic recording apparatus to be used in the present invention, and the apparatus has a photoreceptor 1, an electrification device 2, an exposure device 3, a development device 4, a transfer device 5, a cleaning device 6 and a fixing device 7.

The photoreceptor 1 is formed of an electrically conductive material such as aluminum and has a photosensitive layer formed by coating a photosensitive conductive material on the circumferential surface. Along the circumferential surface of the photoreceptor 1, the electrification device 2, the exposure device 3, the development device 4, the transfer device 5 and the cleaning device 6 are, respectively, disposed. The electrification apparatus 2 comprises, for example, a well known Scorotoron electrification device or a roller electrification device and uniformly charges the surface of the photoreceptor 1 to a predetermined potential. The photoreceptor is preferably accommodated together with the electrification apparatus in a cartridge (a photoreceptor cartridge), which is then set in an image-forming apparatus. By such a construction, it becomes easy to replace the photoreceptor or the electrification apparatus, when such a photoreceptor or electrification apparatus deteriorates.

The exposure device 3 is a device to carry out exposure of the photosensitive surface of the photoreceptor 1 with e.g. a laser beam or LED to form an electrostatic latent image on the photosensitive surface of the photoreceptor 1.

The development device 4 comprises an agitator 42, a feed roller 43, a developing roller 44 and a controller 45, and a toner T is stored in its interior. Further, as the case requires, a supply device (not shown) for supplying a toner may be provided to the development device, and the toner may be supplied to the supply device from a container such as a bottle or a cartridge.

The feed roller 43 is made of a conductive sponge or the like and is in contact with the developing roller 44. The developing roller 44 is disposed between the photoreceptor 1 and the feed roller 43. The developing roller 44 is in contact with each of the photoreceptor 1 and the feed roller 43. The feed roller 43 and the developing roller 44 are rotated by a rotation driving mechanism. The feed roller 43 carries the stored toner and supplies it to the developing roller 44. The developing roller 44 carries the toner supplied by the feed roller 43 and brings it in contact with the surface of the photoreceptor 1.

The developing roller 44 may be a metal roll made of e.g. iron, stainless steel, aluminum or nickel or a resin roll having a resin such as a silicone resin, a urethane resin or a fluorine resin coated on such a metal roll. The surface of the developing roll may be subjected to smoothing or roughening treatment, as the case requires. Further, the developing device is preferably set in the image-forming apparatus in the form of a toner cartridge accommodating a toner, whereby supply of the toner can be facilitated.

The controller 45 is formed by e.g. a resin blade of e.g. a silicone resin or a urethane resin, a metal blade of e.g. stainless steel, aluminum, copper, brass or phosphor bronze, or a blade having a resin coated on such a metal blade. This controller 45 abuts against the developing roller 44 and is pressed with a predetermined force towards the developing roller 44 by e.g. a spring (usual blade linear pressure: 5 to 500 g/cm), and if necessary, it may be provided with a function to impart static electrification to the toner by triboelectrification with the toner.

The agitators 42 are, respectively, rotated by rotation driving mechanisms and designed to agitate the toner and to transport the toner towards the feed roller 43. A plurality of agitators may be provided which differ in e.g. the size or the shape of vanes.

The transfer device 5 is composed of e.g. a transfer charger, a transfer roller or a transfer belt disposed against the photoreceptor 1. This transfer device 5 is designed to apply a predetermined voltage (a transfer voltage) in a reversed polarity to the electrification potential of the toner and to transfer the toner image formed on the photoreceptor 1 to the recording paper P. Depending upon the image-forming apparatus, there is a case where the toner image on the photoreceptor is transferred directly to the recording paper P, or a case where it is transferred via an intermediate transfer belt (not shown) to the recording paper P.

The cleaning device 6 is composed of a cleaning member such as a fur brush or a blade of e.g. urethane and is designed to scrape off the remaining toner attached to the photoreceptor 1 by the cleaning member thereby to recover the remaining toner. Depending upon the image-forming apparatus, no cleaning device may be provided.

The fixing device 7 comprises an upper fixing member 71 and a lower fixing member 72 and has a heating means 73 in the upper or lower fixing member. The fixing member may be a known thermal fixing member such as a fixing roll having a silicon rubber coated on a metal base pipe of e.g. stainless steel or aluminum, a fixing roll further coated with a Teflon resin, or a fixing sheet. Further, in order to improve the release property to the fixing member, a release agent such as silicone oil, may be supplied. Further, the upper fixing member and the lower fixing member may be provided with a mechanism to exert a pressure by e.g. a spring.

The toner transferred onto the paper P, is heated to a molten state when it passes between the upper fixing member 71 and the lower fixing member 72 heated to a predetermined temperature, and cooled after the passage, whereby the toner will be fixed on the recording paper P.

By the electrophotographic development apparatus constructed as described above, recording of an image is carried out as follows. Firstly, the surface (the photosensitive surface) of the photoreceptor 1 will be electrified at a predetermined potential (such as −600V) by the electrification device 2. Then, the photosensitive surface of the photoreceptor 1 thus electrified, will be exposed by the exposure device 3 in accordance with the image to be recorded, to form an electrostatic latent image on the photosensitive surface. Then, development of the electrostatic latent image formed on the photosensitive surface of the photoreceptor 1 is carried out by the development device 4.

In the development device 4, a toner supplied from the feed roller 43 is formed into a thin layer by the developing blade 45 and triboelectrified in a predetermined polarity (here in the same polarity as the electrification potential of the photoreceptor 1, i.e. negative polarity), and it is carried by the developing roller 44, transported and brought in contact with the surface of the photoreceptor 1.

From the developing roller 44, a toner image corresponding to the electrostatic latent image will be formed on the surface of the photoreceptor 1 by a so-called inverse development method. Then, this toner image is transferred to the paper P by the transfer device 5. Thereafter, the toner remaining without being transferred, on the photosensitive surface of the photoreceptor 1, will be removed by the cleaning device 6. The toner after the transfer on the recording paper P is passed through the fixing device 7 and thereby heat-fixed, to obtain a final image.

Now, one example of a tandem system electrophotographic recording apparatus using a non-magnetic one component toner as full color, will be described. FIG. 2 is a schematic view of the main construction of the full color tandem system which comprises a photoreceptor 1, an electrification device 2, an exposure device 3, a black development device 4k, a cyan development device 4c, a yellow development device 4y, a magenta development device 4m, a transfer device 5 and a fixing device 7, and here, a cleaning device is omitted. A color image can be obtained as a full color image by overlaying toners of magenta, yellow, cyan and black in multilayers to obtain a desired color.

In the case of a tandem system, it is preferred that the color development section is located prior to the black development section, since color mixture due to e.g. reverse transfer of a black toner, will be small, and it is preferred that the black development section is located after the color development section, since the color mixture by photoreceptor fogging of a color toner will be little when an image is formed with a single color of black only, and the speed for the formation of a black image can be increased by transporting a recording paper by short passing the color development section.

When the image-forming method of the present invention is to be applied for the formation of full color images, it is preferred to employ a tandem system wherein such cyan, magenta and yellow color development sections are located before, and the black development section is located after the color development sections. Here, the order in location of the cyan, magenta and yellow color development sections can optionally freely be changed.

The toner to be used in the present invention contains at least a binder resin and a colorant and may contain a charge control agent, wax or other additives, as the case requires.

As a method for producing a toner to be used in the present invention, there may be mentioned a method of improving the precision of the classifier for a toner produced by a conventional kneading/pulverization method, or a method for producing it by a wet system polymerization method such as a suspension polymerization method or an emulsion polymerization/agglomeration method. In order to prepare the toner of the invention efficiently, it is preferred to employ a wet system polymerization method.

Further, in order to accomplish a suitable particle size distribution for the toner of the present invention, an emulsion polymerization/agglomeration method is particularly preferred. The emulsion polymerization/agglomeration method is advantageous also in that the circularity of the toner can optionally be controlled.

The binder resin for the toner can be selected within a wide range including conventional resins. Preferably, a styrene type polymer such as a styrene/acrylate copolymer, a styrene/methacrylate copolymer or an acrylic acid copolymer of such a resin, a saturated or unsaturated polyester type polymer or an epoxy type polymer, may be mentioned. Such binder resins may be used not only alone but also in combination as a mixture of two or more of them.

The colorant may be an inorganic pigment, an organic pigment or an organic dye, or a combination thereof. As specific examples, known optional dyes and pigments, such as carbon black, aniline blue, phthalocyanine blue, phthalocyanine green, Hansa Yellow, Rhodamine type dyes and pigments, Chrome Yellow, quinacridone, Benzidine Yellow, Rose Bengale, triallylmethane type dyes, and monoazo type, disazo type and condensed azo type dyes and pigments, may be used alone or in admixture. In the case of a full color toner, it is preferred to use Benzidine Yellow or a monoazo type or condensed azo type dye or pigment as a yellow colorant, quinacridone or a monoazo type dye or pigment as a magenta colorant, and phthalocyanine blue as a cyan colorant.

Among them, the cyan colorant is preferably C.I. pigment blue 15:3; the yellow colorant is preferably C.I. pigment yellow 74 or C.I. pigment yellow 93; and the magenta colorant is preferably C.I. pigment red 238, C.I. pigment red 269, C.I. pigment red 57:1, C.I. pigment red 48:2, or C.I. pigment red 122.

The amount of the colorant is preferably within a range of from 2 to 25 parts by weight, per 100 parts by weight of the binder resin.

In order to secure the charging stability and the predetermined charging degree, a charge control agent may be incorporated to the toner to be used in the present invention.

As such a charge control agent, a conventional compound may be used. For example, a metal complex of a hydroxycarboxylic acid, a metal complex of an azo compound, a naphthol type compound, a metal compound of a naphthol type compound, a Nigrosine type dye, a quaternary ammonium salt or a mixture thereof, may be mentioned.

The amount of the charge control agent is preferably within a range of from 0.1 to 5 parts by weight per 100 parts by weight of the binder resin.

To the toner to be used in the present invention, it is preferred to add wax in order to impart a release property from e.g. a fixing roller. As the wax, any wax may be employed so long as it has a release property.

Specifically, an olefin type wax such as a low molecular weight polyethylene, a low molecular weight polypropylene or a copolymer polyethylene; paraffin wax; an ester type wax having a long chain aliphatic group, such as behenyl behenate, a montanate or stearyl stearate; a vegetable wax such as hydrogenated castor oil or carnauba wax; a ketone having a long chain alkyl group, such as distearyl ketone; a silicone having an alkyl group; a higher fatty acid such as stearic acid; a long chain aliphatic alcohol such as eicosanol; a carboxylic acid ester or partial ester of a polyhydric alcohol obtained from a polyhydric alcohol such as glycerol or pentaerythritol and a long chain fatty acid; a higher aliphatic acid amide such as oleic acid amide or stearic acid amide; or a low molecular weight polyester, may, for example, be mentioned.

Among these waxes, in order to improve the fixing property, the melting point of the wax is preferably at least 30° C., more preferably at least 40° C., particularly preferably at least 50° C. Further, it is preferably at most 100° C., more preferably at most 90° C., particularly preferably at most 80° C. If the melting point is too low, the wax tends to be exposed on the surface after the fixing, thus leading to stickiness, and if the melting point is too high, the fixing property at a low temperature tends to be poor.

Further, with respect to the compound type of the wax, an ester type wax obtainable from an aliphatic carboxylic acid and a monohydric or polyhydric alcohol, is preferred. Among ester type waxes, one having a carbon number of from 20 to 100 is more preferred, and one having a carbon number of from 30 to 60 is particularly preferred.

As particularly preferred compounds among esters of monohydric alcohols with aliphatic carboxylic acids, behenyl behenate and stearyl stearate are mentioned. As particularly preferred compounds among esters of polyhydric alcohols with aliphatic carboxylic acids, a stearic acid ester or partial ester of pentaerythritol, and montanic acid ester or partial ester of glycerol, are mentioned.

The above waxes may be used alone or in admixture. Further, depending upon the fixing temperature for fixing the toner, the melting point of the wax compound may optionally be selected.

The amount of the wax is usually from 0.1 to 40%, preferably from 1 to 40%, more preferably from 5 to 30% in the toner.

Now, a wet system polymerization method will be described as a preferred method for preparing the toner to be used in the present invention.

In an emulsion polymerization/agglomeration method, a colorant dispersion, a charge control agent dispersion, a wax dispersion, etc., are mixed to a dispersion of primary particles of a polymer, and the temperature, the salt concentration, the pH, etc., are optionally controlled to agglomerate the particles to obtain a toner.

As an emulsifier to be used for the above emulsion polymerization, at least one emulsifier selected from the group consisting of a cationic surfactant, an anionic surfactant and a nonionic surfactant, may be used.

Specific examples of the cationic surfactant include dodecylammonium chloride, dodecylammonium bromide, dodecyltrimethylammonium bromide, dodecylpyridinium chloride, dodecylpyridinium bromide, and hexadecyltrimethylammonium bromide.

Specific examples of the anionic surfactant include fatty acid soaps such as sodium stearate and sodium dodecanate, sodium dodecylsulfate, sodium dodecylbenzenesulfonate, and sodium laurylsulfate.

Specific examples of the nonionic surfactant include polyoxyethylene dodecyl ether, polyoxyethylene hexadecyl ether, polyoxyethylene nonylphenyl ether, polyoxyethylene lauryl ether, polyoxyethylene sorbitan monooleate ether, and monodecanoyl sucrose.

Among these surfactants, an alkali metal salt of a straight chain alkylbenzenesulfonic acid is preferred.

In the suspension polymerization method, a colorant, a charge control agent, wax, etc., are mixed to a polymerizable monomer, followed by dispersion treatment by means of a dispersion machine such as a disperser. The monomer composition after this dispersion treatment is granulated in a water-miscible medium to a toner particle size by means of a suitable stirrer, followed by polymerization of the polymerizable monomer to produce a toner.

When a suspension stabilizer is employed, it is preferred to select one showing a neutral or alkaline nature in water, which can readily be removed by washing the toner with an acid after the polymerization. Further, it is preferred to select one whereby a toner having a narrow particle size distribution can be obtained. As a suspension stabilizer satisfying these conditions, calcium phosphate, tricalcium phosphate, magnesium phosphate, calcium hydroxide or magnesium hydroxide, may, for example, be mentioned. These stabilizers may be used alone or in combination as a mixture or two or more of them. Such a suspension stabilizer may be used in an amount of from 1 to 10 parts by weight, relative to the radical polymerizable monomer.

As a polymerization initiator to be used for the emulsion polymerization/agglomeration method or the suspension polymerization method, one or more of known polymerization initiators may be used. For example, potassium persulfate, 2,2′-azobisisobutyronitrile, 2,2′-azobisiso(2,4-dimethyl)valeronitrile, benzoyl peroxide, lauroyl peroxide or a redox type initiator, may for example, be used.

Among them, a redox type initiator is preferred for the emulsion polymerization/agglomeration method, and an azo type initiator is preferred for the suspension polymerization method.

After the preparation of the toner by the above method, a polymer emulsion, a colorant dispersion, a charge control agent dispersion or a wax dispersion may, for example, be added to cover the toner surface thereby to obtain a toner having a capsule structure.

Now, the emulsion polymerization/agglomeration method as the most preferred method for the production of the toner of the present invention, will be described in further detail.

The process for producing a toner by the emulsion polymerization/agglomeration method usually comprises a polymerization step, a mixing step, a agglomeration step and a cleaning/drying step.

Namely, to the dispersion containing primary particles of the polymer obtained by the emulsion polymerization, dispersions of a colorant, a charge control agent, wax, etc. are mixed to agglomerate primary particles in this dispersion to form particle agglomerates having a volume average particle diameter of from 3 to 8 μm. If necessary, fine resin particles, etc., may be deposited thereto, and if necessary, the particle agglomerates, or the particle agglomerates having fine resin particles attached, are fused. The toner particles thus obtained are washed and dried to obtain toner particles as a commercial product.

Polymer Primary Particles

The polymer primary particles to be used in the emulsion polymerization/agglomeration method are preferably those having a glass transition temperature (Tg) of from 40 to 80° C. and an average particle diameter of from 0.02 to 3 μm. Such polymer primary particles can be obtained by emulsion polymerization of a monomer.

For the emulsion polymerization, a monomer having a Brøonsted acidic group (which may hereinafter be sometimes referred to simply as an acidic group) or a monomer having a Brønsted basic group (which may hereinafter be referred to simply as a basic group), and a monomer having neither a Brønsted acidic group nor a Brønsted basic group (which may hereinafter be referred to as other monomer) are added consecutively to advance the polymerization. At that time, the monomers may be added separately, or a plurality of monomers may preliminarily be mixed and added. Further, the monomer composition may be changed during the addition of the monomers. Further, the monomers may be added as they are, or they may be mixed with water or an emulsifier beforehand and may be added in the form of a prepared emulsion. As the emulsifier, one or a combination of two or more of surfactants, is selected from the above-mentioned surfactants.

The monomer having a Brønsted acidic group to be used in the present invention, may, for example, be a monomer having a carboxyl group such as acrylic acid, methacrylic acid, maleic acid, malic acid or cinnamic acid, a monomer having a sulfonic group such as styrene sulfonate, or a monomer having a sulfonamide group such as vinyl benzenesulfonamide.

The monomer having a Brønsted basic group, may, for example, be an aromatic vinyl compound having an amino group, such as aminostyrene, a nitrogen-containing heterocyclic monomer such as vinylpyridine or vinylpyrrolidone, or a (meth)acrylate having an amino group, such as dimethylaminoethyl acrylate or diethylaminoethyl methacrylate. Further, the monomer having such an acidic group or a monomer having such a basic group, may be present in the form of a base having the respective counter ion.

The blend ratio of such a monomer having a Brønsted acidic group or a Brønsted basic group in the monomer mixture to constitute polymer primary particles, is preferably at least 0.05 wt %, more preferably at least 1 wt %, and preferably at most 10 wt %, more preferably at most 5 wt %. Among monomers having Brønsted acidic groups or Brønsted basic groups, acrylic acid or methacrylic acid is particularly preferred.

Other comonomers may, for example, be a styrene such as styrene, methylstyrene, chlorostyrene, dichlorostyrene, p-tert-butylstyrene, p-n-butylstyrene or p-n-nonylstyrene, a (meth)acrylate such as methyl acrylate, ethyl acrylate, propyl acrylate, n-butyl acrylate, isobutyl acrylate, hydroxyethyl acrylate, ethylhexyl acrylate, methyl methacrylate, ethyl methacrylate, propyl methacrylate, n-butyl methacrylate, isobutyl methacrylate, hydroxyethyl methacrylate or ethylhexyl methacrylate, acrylamide, N-propylacrylamide, N,N-dimethylacrylamide, N,N-dipropylacrylamide, N,N-dibutylacrylamide, and acrylic acid amide. Among them, styrene or butyl acrylate is, for example, particularly preferred.

Further, when a crosslinked resin is used as polymer primary particles, as a crosslinking agent to be used together with the above-mentioned monomer, a polyfunctional monomer having radial polymerizability, is employed, which may, for example, be divinylbenzene, hexanediol diacrylate, ethylene glycol dimethacrylate, diethylene glycol dimethacrylate, diethylene glycol diacrylate, triethylene glycol diacrylate, neopentyl glycol dimethacrylate, neopentyl glycol acrylate, or diallyl phthalate. Further, it is possible to employ a monomer having a reactive group as a pendant group, such as glycidyl methacrylate, methylol acrylamide or acrolein.

Particularly, a radical polymerizable bifunctional monomer is preferred, and more preferred is divinylbenzene or hexanediol diacrylate.

The blend ratio of such a polyfunctional monomer in the monomer mixture is preferably at least 0.005 wt %, more preferably at least 0.1 wt %, particularly preferably at least 0.3 wt %, and preferably at most 5 wt %, more preferably at most 3 wt %, particularly preferably at most 1 wt %.

These monomers may be used alone or in admixture, whereby the glass transition temperature of the polymer will preferably be from 40 to 80° C. If the glass transition temperature exceeds 80° C., the fixing temperature tends to be too high, or deterioration of the OHP transparency is likely to be problematic. On the other hand, if the glass transition temperature of the polymer is lower than 40° C., the storage stability of the toner is likely to be poor.

The polymerization initiator may be added to the polymerization system at any time i.e. before, after or at the same time as the addition of the monomer, and these methods of addition may be combined, as the case requires.

For the emulsion polymerization, a known chain transfer agent may be used, as the case requires. As a specific example of such a chain transfer agent, t-dodecylmercaptan, 2-mecaptoethanol, diisopropylxanthogene, carbon tetrachloride or trichlorobromomethane, may, for example, be mentioned. Chain transfer agents may be used alone or in combination as a mixture of two or more of them. The chain transfer agent is used in an amount of from 0 to 5 wt %, based on the polymerizable monomer.

For the emulsion polymerization, the above-mentioned monomers are mixed with water and polymerized in the presence of a polymerization initiator, and the polymerization temperature is usually from 50 to 150° C., preferably from 60 to 120° C., more preferably from 70 to 100° C.

The volume average particle diameter of polymer primary particles thus obtained is usually within a range of from 0.02 to 3 μm, preferably from 0.05 to 3 μm, more preferably from 0.1 to 2 μm, particularly preferably from 0.1 to 1 μm. The average particle diameter can be measured, for example, by means of UPA. If the particle diameter is smaller than 0.02 μm, the control of the agglomeration rate tends to be difficult, such being undesirable. Further, if it exceeds 3 μm, the particle diameter of the toner obtainable by agglomeration tends to be large, and such is not suitable for the production of a toner of from 3 to 8 μm.

Colorant

In the emulsion polymerization/agglomeration method, colorant particles are mixed to the dispersion of polymer primary particles to obtain a mixed dispersion, which is then agglomerated to obtain particle agglomerates. The colorant is preferably emulsified in water in the presence of an emulsifier (the above-mentioned surfactant) and is used in the state of an emulsion. The volume average particle diameter of the colorant particles is preferably from 0.01 to 3 μm.

The amount of the colorant is usually from 1 to 25 parts by weight, preferably from 3 to 20 parts by weight, per 100 parts by weight of the polymer primary particles.

Wax

In the emulsion polymerization/agglomeration method, wax is preferably preliminarily dispersed in the presence of an emulsifier (the above-mentioned surfactant) and used in the form of an emulsified dispersion of fine particles of wax.

The wax is permitted to be present in the agglomeration step. This may be carried out in such a manner that the dispersion of fine particles of wax is subjected to coagglomeration with the polymer primary particles and the colorant particles, or in such a manner that in the presence of the dispersion of fine particles of wax, the monomer is subjected to seed emulsion polymerization to prepare polymer primary particles internally containing wax, which are agglomerated together with colorant particles.

In order to uniformly disperse the wax in the toner, it is preferred to let the dispersion of fine particles of wax be present at the time of the preparation of the above-mentioned polymer primary particles, i.e. at the time of polymerization of the monomer.

The average particle diameter of the fine particles of wax is preferably from 0.01 to 3 μm, more preferably from 0.1 to 2 μm, particularly preferably from 0.3 to 1.5 μm. Here, the average particle diameter can be measured, for example, by means of LA-500, manufactured by Horiba Co. If the average particle diameter of the wax emulsion exceeds 3 μm, it tends to be difficult to control the particle diameter during the agglomeration. On the other hand, if the average particle size of the emulsion is smaller than 0.01 μm, it tends to be difficult to prepare the dispersion.

Charge Control Agent

In the emulsion polymerization/agglomeration method, as a method of incorporating a charge control agent, a charge control agent may be employed as seeds together with wax at the time of obtaining polymer primary particles, or a charge control agent may be employed as dissolved or dispersed in the monomer or the wax, or primary particles of a charge control agent may be agglomerated together with the polymer primary particles and the colorant to form particle agglomerates, or the polymer primary particles and the colorant are agglomerated to a particle size suitable for a toner, and then primary particles of a charge control agent may be added for agglomeration.

In such a case, it is preferred that the charge control agent is dispersed in water by means of an emulsifier (the above-mentioned surfactant) and is used in the form of an emulsion having an average particle diameter of from 0.01 to 3 μm (primary particles of the charge control agent).

Mixing Step

In the agglomeration step in the process of the present invention, the above-mentioned polymer primary particles and colorant particles, particles of optional blend components such as the charge control agent and wax, are mixed and dispersed simultaneously or consecutively. It is preferred that preliminarily, the dispersions of the respective components, i.e. the dispersion of the polymer primary particles, the dispersion of the colorant particles, optionally, the dispersions of the charge control agent and the dispersion of fine particles of wax, are prepared, and these dispersions are mixed to obtain a mixed dispersion.

Further, the wax is preferably incorporated to the toner, as internally contained in the polymer primary particles, i.e. by using polymer primary particles obtained by emulsion polymerization using wax as seeds. In such a case, wax internally contained in the polymer primary particles and fine particles of wax not internally contained, may be used in combination. It is more preferred to employ it in the form where substantially the entire amount of wax is internally contained in the polymer primary particles.

Agglomeration Step

The mixed dispersion of the above-mentioned respective particles is subjected to agglomeration in the agglomeration step to prepare particle agglomerates. For this agglomeration treatment, 1) a method of heating in an agitation tank, 2) a method of adding an electrolyte, or 3) a method of combining them, may be mentioned.

In a case where primary particles are agglomerated under stirring to obtain particle agglomerates having a size substantially the same as the toner, the particle diameter of the particle agglomerates is controlled from the balance of the agglomeration force of the particles one another and the shearing force by stirring, but it is possible to increase the agglomeration force of the primary particles by heating or by adding an electrolyte.

In a case where agglomeration is carried out under heating, the agglomeration temperature is specifically within a range of from 5° C. to Tg (where Tg is the glass transition temperature of the polymer primary particles), preferably within a range of from Tg−10° C. to Tg−5° C. Within the above temperature range, the particles can be agglomerated to obtain a preferred toner particle size without using an electrolyte. In a case where agglomeration is carried out by an addition of an electrolyte, the agglomeration temperature is preferably from 5° C. to Tg, more preferably from Tg−10° C. to Tg−5° C. Here, Tg of the polymer primary particles to be used in the present invention is preferably from 40 to 80° C. In order to control the particle diameter of toner particles to the predetermined particle diameter (from 3 to 8 μm), the agglomeration temperature at the prescribed level is maintained usually for at least 30 minutes to 1 hour, whereby toner particles of the desired particle diameter can be obtained. The temperature may be raised to the prescribed temperature at a constant rate, or the temperature may be raised stepwise.

In the case where agglomeration is carried out by an addition of an electrolyte to the mixed dispersion, the electrolyte may, for example, be an organic salt or an inorganic salt, but is preferably a monovalent or polyvalent metal salt. Specifically, NaCl, KCl, LiCl, Na₂SO₄, K₂SO₄, Li₂SO₄, MgCl₂, CaCl₂, MgSO₄, CaSO₄, ZnSO₄, Al₂(SO₄)₃, Fe₂(SO₄)₃, CH₃COONa or C₆H₅SO₃Na, may, for example, be mentioned. Among them, an inorganic salt having a polyvalent metal cation, is more preferred.

The amount of the electrolyte to be added, varies depending upon the type of the electrolyte, but it is usually from 0.05 to 25 parts by weight, preferably from 0.1 to 15 parts by weight, more preferably from 0.1 to 10 parts by weight, per 100 parts by weight of the solid content in the mixed dispersion.

If the amount of the electrolyte is substantially smaller than the above range, the agglomeration reaction tends to be slow, and a fine particle of at most 1 μm is likely to remain after the agglomeration reaction, or a problem is likely to result such that the average particle size of the obtained particle agglomerates becomes 3 μm or smaller. On the other hand, if the amount of the electrolyte substantially exceeds the above range, agglomeration tends to be rapid and hardly controllable, and a coarse particle of at least 25 μm is likely to be included in the obtained particle agglomerates, or a problem is likely to result such that the shape of the agglomerates tends to be deformed and irregular.

Other Blend Components

In the present invention, it is preferred that fine particles of a resin are covered (deposited or fixed) on the surface of the particle agglomerates after the above agglomeration treatment, to form toner particles, as the case requires.

When the above-described charge control agent is added after the agglomeration treatment, it is preferred that the charge control agent is added to the dispersion containing the particle agglomerates, and then the fine particles of a resin are added. Such fine particles of a resin are used in the form of an emulsion as dispersed in water or in a liquid containing water as the main component by means of an emulsifier (the above-mentioned surfactant), but the fine particles of a resin to be used as the outermost layer of the toner are preferably those containing no wax.

The fine particles of a resin preferably have a volume average particle diameter of from 0.02 to 3 μm, more preferably from 0.05 to 1.5 μm, and those obtained by polymerizing a monomer similar to the monomer employed for the above-mentioned polymer primary particles, may be employed.

When the fine particles of a resin are coated on the particle agglomerates to form a toner, the resin used for the fine particles of a resin is preferably a crosslinked resin.

Aging Step

In the emulsion polymerization/agglomeration method, it is preferred to add an aging step to create fusion among agglomerated particles within a range of from Tg+20° C. to Tg+80° C. (where Tg is the glass transition temperature of the polymer primary particles) in order to increase the stability of the particle agglomerates (toner particles) obtained by agglomeration. Further, in this aging step, it is preferred to maintain the agglomerates in the above temperature range for at least one hour. By adding this aging step, the shape of toner particles can be made to be almost spherical, and control of the shape will be possible. This aging step is usually from 1 to 24 hours, preferably from 1 to 10 hours.

The particle agglomerates prior to the aging step are considered to be aggregates formed by electrostatic or other physical agglomeration of primary particles. Whereas, after the aging step, the polymer primary particles constituting the particle agglomerates are mutually fused, and the agglomerates are preferably substantially spherical. By this method for producing a toner, it is possible to produce toners having various shapes depending upon the particular purposes, such as a grape shape in which primary particles are in a agglomerated state, a potato shape in which fusion has proceeded halfway, and a spherical shape in which fusion has proceeded further.

Washing/Drying Step

The particle agglomerates obtained by the above respective steps are subjected to solid/liquid separation by a conventional method to recover the particle agglomerates, which are then washed as the case requires, and dried to obtain the desired toner particles.

Thus, a toner having a relatively small particle diameter such that the volume average particle diameter is from 3 to 8 μm, can be produced. The toner thus obtained has a sharp particle size distribution and is suitable as a toner for electrostatic image development to accomplish a high image quality and high speed.

To the toner to be used in the present invention, a conventional additive may be added in order to control the flowability or the developability. As such an additive, various inorganic oxide particles such as silica, alumina or titania (which may be subjected to hydrophobic treatment, as the case requires) or vinyl polymer particles, may, for example, be employed. The amount of the additive is preferably within a range of from 0.05 to 5 parts by weight, relative to the toner particles.

The toner to be used in the present invention can be applied to a two component developer, a magnetic one component developer such as a magnetite-containing toner, or a non-magnetic one component developer.

When used as a two component developer, a carrier to be mixed with the toner to form a developer, may be a conventional magnetic material such as iron powder type, ferrite type or magnetite type carrier, or one having a resin coating applied to the surface thereof, or a magnetic resin carrier, may be employed.

The coating resin for the carrier may be a commonly known styrene type resin, an acrylic resin, a styrene/acryl copolymer resin, a silicone resin, a modified silicone resin or a fluorine type resin, but it is not limited to such a specific example. The average particle size of the carrier is not particularly limited, but one having an average particle diameter of from 10 to 200 μm, is preferred. Such a carrier is used preferably in an amount of from 5 to 100 parts by weight, per 1 part by weight of the toner.

As a method for measuring the particle diameter of the toner, a commercially available particle diameter measuring apparatus may be employed. Typically, a precise particle size distribution measuring apparatus Coulter counter multisizer II, manufactured by Beckman Coulter, Inc., may be employed.

The toner to be used in the present invention has a volume average particle size (Dv) of from 3 to 8 μm. The volume average particle diameter is preferably from 4 to 8 μm, more preferably from 4 to 7 μm. If the volume average particle diameter is too large, such is not suitable for forming an image having a high resolution, and if it is too small, handling as a powder tends to be difficult.

The particle size distribution of the toner is preferably sharp, whereby electrification tends to be uniform. Specifically, in the image-forming method and apparatus of the present invention, a toner satisfying a relation of 1.0≦Dv/Dn≦1.3 where Dv is the volume average particle diameter, and Dn is the number average particle diameter, is employed. The value of Dv/Dn is preferably at most 1.25, more preferably at most 1.20. Further, the lower limit value of Dv/Dn is 1, but this means that all particle diameters are equal, and it is difficult to produce such a toner. Accordingly, it is preferably at least 1.03, more preferably at least 1.05.

Further, the toner preferably contains fine particles (fine powder) as little as possible. When fine particles are little, the flowability of the toner improves, and the colorant or the charge control agent will be uniformly distributed, whereby the electrification tends to be uniform.

To measure the fine particles, a flow type particle image analyzing apparatus FPIA-2000, manufactured by Sysmex Corporation, may suitably be employed.

In the present invention, it is preferred to employ a toner whereby the measured value (the number) of particles of from 0.6 to 2.12 μm by a flow type particle image analyzing apparatus, is at most 15% of the total number of particles. This means that the amount of fine particles is smaller than a certain amount. However, the number of particles of from 0.6 to 2.12 μm is more preferably at most 10%, particularly preferably at most 5%, most preferably at most 3%. Further, there is no particular lower limit for such fine particles, and it is most preferred that such fine particles are not present at all, but such is difficult from the practical viewpoint. Accordingly, the amount is usually at least 0.05%, preferably at least 0.1%.

As other indices for a toner containing little fine powder, the following may be mentioned. 1) In the toner, particles having particle diameters of not more than 40% of the volume average particle diameter are preferably not more than 9.0 number %, more preferably not more than 8.0 number %. 2) In the toner, particles having particle diameters of not more than 55% of the volume average particle diameter are preferably not more than 5.0 vol %, more preferably not more than 4.0 vol %. 3) In the toner, particles having particle diameters of not more than 55% of the volume average particle diameter are preferably not more than 20 number %, more preferably not more than 16 number %.

Further, the shape of the toner is preferably as close as possible to a spherical shape. Specifically, as a method of quantifying the shape of the toner, the toner is measured by a flow type particle image analyzing apparatus FPIA-2000, manufactured by Sysmex Corporation, and the circularity corresponding to the cumulative particle size value at 50% of the value obtained by the following formula (I), is defined as the 50% circularity, whereby the 50% circularity is preferably within a range of from 0.9 to 1.

Circularity=Peripheral length of a circle having the same area as the area of the projected image of a particle/Peripheral length of the projected image of the particle (I)

The 50% circularity of a toner represents the degree of irregularities of a toner particle, and it becomes 1 when the toner is completely spherical. The more complex the surface shape, the smaller the value of the circularity.

The closer the shape to sphere, the less likely the localization of electrification within the particle and the more uniform the developability. Accordingly, the 50% circularity of a toner is more preferably at least 0.92, particularly preferably at least 0.95. It is practically difficult to prepare complete spheres, and accordingly, the 50% circularity is usually at most 0.995, more likely at most 0.99.

Now, the photoreceptor to be used in the present invention will be described.

The photoreceptor to be used in the present invention has at least a photosensitive layer on an electroconductive substrate. The photosensitive layer is preferably of a laminate type having a charge generation layer and a charge transport layer laminated.

The charge generation layer and the charge transport layer are formed on the electroconductive substrate in the order of the charge generation layer and the charge transport layer or in the order of the charge transport layer and the charge generation layer. It is particularly preferred to take a construction such that the charge transport layer is laminated on the charge generation layer.

Further, in addition to these layers, a layer to improve the electrical characteristics or mechanical characteristics, such as an adhesive layer, an interlayer such as a blocking layer, or a protective layer, may be formed. In the case of a photoreceptor having a charge generation layer and a charge transport layer formed in this order on a substrate, an interlayer is formed usually between the substrate and the charge generation layer, and a protective layer is formed usually on the charge transport layer.

As the electroconductive substrate, any substrate which is employed for conventional electrophotographic photoreceptors, may be employed. Specifically, a metal drum or sheet of e.g. aluminum, stainless steel or copper, or a laminate or vapor deposited product of such a metal, may be mentioned. Further, a plastic film, plastic drum, paper, paper tube, etc. having electroconductive treatment applied by coating an electroconductive material such as a metal powder, carbon black, copper iodide or a polymer electrolyte together with a suitable binder, may be mentioned. Further, an electroconductive plastic sheet or drum containing an electroconductive material such as a metal powder, carbon black or carbon fiber, may be mentioned. Still further, a plastic film or belt having electroconductive treatment applied with an electroconductive metal oxide such as tin oxide or indium oxide, may be mentioned.

The electroconductive substrate is preferably of a drum shape, when it is used for a small size, high speed electrophotographic apparatus. In such a case, the inner diameter of the drum is usually from 10 to 40 mm, preferably from 13 to 35 mm, more preferably from 16 to 30 mm. In the case of a small size apparatus, it is particularly preferably from 13 to 25 mm. In the case of a color electrophotographic apparatus wherein photoreceptors are employed, respectively, for four color toners of cyan, magenta, yellow and black, the above-mentioned small size drum is particularly advantageous.

A blocking layer may be provided, as the case requires, between the electroconductive substrate and the charge generation layer. As such a blocking layer, an alumite layer or a undercoating layer of a resin (or an interlayer), or a combination thereof, may be employed.

When an alumite layer is to be provided, it is preferred to use an aluminum substrate as the electroconductive substrate, and this substrate is subjected to degreasing treatment by various degreasing or washing methods with an acid, alkali, organic solvent, surfactant or emulsion, or electrolysis.

Then, in an acidic bath of e.g. chromic acid, sulfuric acid, oxalic acid, boric acid or sulfamic acid, preferably in a sulfuric acid bath, anodic oxidation treatment is applied to form an anodic oxide coating (an alumite layer). The average thickness of the anodic oxide coating is usually from 1 to 20 μm, preferably from 1 to 7 μm.

The obtained anodic oxide coating may be used as it is, but it is porous and poor in weather resistance and susceptible to corrosion or the like. Accordingly, it is preferred to apply sealing treatment i.e. treatment to seal the pores.

As such sealing treatment, a low temperature sealing treatment for dipping in an aqueous solution containing nickel fluoride as the main component, or a high temperature sealing treatment for dipping in an aqueous solution containing nickel acetate as the main component, may be applied to the anodic oxide coating formed as described above.

The alumite layer formed as described above will be subjected to washing treatment by washing by dipping in water, exposing to water stream or spraying of water, washing by physical contact with a brushing material in the form of a brush, a foam or a cloth, or by combined use thereof, followed by drying treatment such as drying in air or heat drying.

To provide an undercoating layer on the electroconductive substrate, as the binder resin, a resin material such as polyvinyl methyl ether, poly-N-vinyl imidazole, polyethylene oxide, ethyl cellulose, methyl cellulose, an ethylene/acrylic acid copolymer, polyamide, casein, gelatin, polyethylene, polyester, a phenol resin, a vinyl chloride/vinyl acetate copolymer, an epoxy resin, polyvinyl pyrrolidone, polyvinyl pyridine, polyurethane, polyglutamic acid, polyacrylic acid or a polyamide resin, may be employed.

Among them, a polyamide resin is preferred which is excellent in the adhesion to the substrate base material and which has a small solubility against a solvent to be used for the coating fluid for a charge generation layer.

The charge generation layer comprises at least a binder polymer and a charge generation agent. In the present invention, oxytitanium phthalocyanine is employed as the charge generation agent. In addition, an organic photoconductive compound, a colorant, an electron attracting compound, etc., may be incorporated, as the case requires.

The binder to be used for the charge generation layer may, for example, be a polymer or copolymer of a vinyl compound, such as styrene, vinyl acetate, vinyl chloride, an acrylate, a methacrylate, vinyl alcohol or ethyl vinyl ether, polyvinyl acetal, polycarbonate, polyester, polyamide, polyurethane, cellulose ester, cellulose ether, a phenoxy resin, a silicone resin or an epoxy resin.

Among them, a polymer or copolymer of a vinyl compound, or a polyvinyl acetal, is preferred. The proportions of the binder polymer and oxytitanium phthalocyanine as the charge generation agent, are not particularly limited. However, it is common to use the binder polymer in an amount of from 5 to 500 parts by weight, preferably from 20 to 300 parts by weight, per 100 parts by weight of oxytitanium phthalocyanine.

One of the features of the present invention is to use a specific crystalline oxytitanium phthalocyanine as the charge generation agent. The crystalline oxytitanium phthalocyanine to be used in the present invention is one showing a distinct diffraction peak at a Bragg angle (2θ±0.2) of 27.3° in the X-ray diffraction by CuKα-ray. Here, the X-ray diffraction is measured by a common Bragg-Brentano concentration technique. Further, the diffraction intensity is usually represented by cps.

Such crystalline oxytitanium phthalocyanine is disclosed, for example, in FIG. 2 of JP-A-62-67094 (in this publication, it is referred to as II type), in FIG. 1 of JP-A-2-8256, in FIG. 1 of JP-A-64-17066, in FIG. 1 of JP-A-63-20365, or in Electrophotographic Association Journal, vol. 92 (1990), No. 3, p. 250-258 (in this publication, it is referred to as Y-type). In this specification, the crystalline oxytitanium phthalocyanine to be employed in the present invention, will be referred to as Y-type in accordance with the naming used in academic literatures.

Y-type is characterized by showing the maximum diffraction peak at 27.3° according to the Bragg-Brentano concentration technique and thereby distinguished from the α-type or the β-type. For example, the crystal type disclosed in JP-A-3-128973 or JP-A-3-269064, is considered to be Y-type although the crystallinity is different.

Further, Y-type shows peaks typically at 7.4°, 9.7° and 24.2°, in addition to 27.3°, although the peaks other than 27.3° may change in the peak intensity or tend to be broad or their positions may be displaced, depending upon the crystallinity (this means that the crystal is not firm).

Further, recently, X-ray diffraction has been carried out by a transmission method wherein the orientation of crystal is excluded as far as possible, and in the transmission method X-ray diffraction by 1.2085 Å using a capillary as a sample holder, Y-type shows peaks at Bragg angles (2θ±0.2) of 21.3°, 18.9°, 7.6° and 5.8°, which correspond, respectively, to 27.3°, 24.2°, 9.7° and 7.4° by CuKα-ray. Further, in high resolution X-ray diffraction, the peak corresponding to 9.7° will be divided into two or more peaks.

In the present invention, for the purpose of e.g. adjusting the sensitivity, a charge generation agent other than Y-type oxytitanium phthalocyanine, may be used in combination. In the case of such combination, if the charge generation material is combined with only a titanium-containing phthalocyanine type compound such as α-type oxytitanium phthalocyanine or β-type oxytitanium phthalocyanine, the proportion of the Y-type oxytitanium phthalocyanine in the charge generation agent is usually at least 30 wt %, preferably at least 50%, more preferably at least 70 wt %. Further, if it is combined with a charge generation agent other than a titanium-containing phthalocyanine type compound, the proportion of Y-type oxytitanium phthalocyanine in the charge generation agent, is usually at least 40 wt %, preferably at least 60 wt %, more preferably at least 80 wt %.

The thickness of the charge generation layer is usually from 0.05 to 5 μm, preferably from 0.1 to 2 μm.

A charge transport layer into which a charge carrier will be injected from the charge generation layer, contains a carrier transport medium (a charge transport agent) having high transport efficiency and high carrier injection efficiency.

The charge transport layer comprises at least a binder and the charge transport agent, and may further contain various additives such as an antioxidant, a sensitizer, a plasticizer, a fluidity-imparting agent and a crosslinking agent, as the case requires.

The charge transport agent may, for example, be a polymer compound having a heterocyclic compound or a condensed polycyclic aromatic compound in its side chain, such as poly-N-vinylcarbazole or polystyrylanthracene, the low molecular compound may, for example, be a heterocyclic compound such as pyrazoline, imidazole, oxazole, oxadiazole, triazole or carbazole, a triarylalkane derivative such as triphenylmethane, a triarylamine derivative such as triphenylamine, a phenylenediamine derivative, an N-phenylcarbazole derivative, a stilbene derivative or a hydrazone compound. Particularly preferred is a compound having a high electron donative nature having an electron donative group such as a substituted amino group or an alkoxy group, or substituted by an aromatic ring having such an electron donative group.

Among them, a compound represented by the formula (III), (IV), (V) or (VI) is preferred.

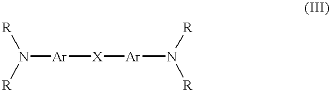

In the formula (III), X is a bivalent residue which may have a substituent, Ar is an aryl group which may have a substituent, and R is an aryl, alkyl, condensed polycyclic or heterocyclic group, which may have a substituent.

In the formula (III), a more preferred structure is such that X is —O—, —S—, —SO₂—, or a bivalent organic residue which may have a substituent, Ar is a phenyl group which may have a substituent, and R is a phenyl group or a naphthyl group, which may have a substituent. A more preferred structure is such that X is a methylene group which may have a substituent, Ar is a phenyl group which may have a substituent, and R is a p-tolyl group which may have a substituent.

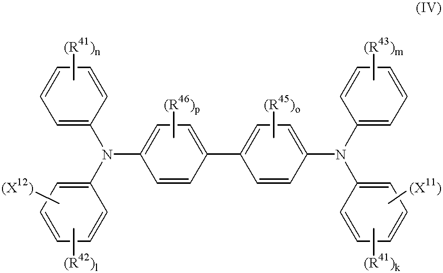

wherein each of R⁴¹, R⁴², R⁴³, R⁴⁴, R⁴⁵ and R⁴⁶ which may be the same or different, is a hydrogen atom, a halogen atom, an alkyl group which may have a substituent, an alkoxy group which may have a substituent, an aryl group which may have a substituent, or a substituted amino group, each of k, l, m, n, o and p is an integer of from 0 to 4, provided that when it is an integer of 2 or more, the plurality of R⁴¹, R⁴², R⁴³, R⁴⁴, R⁴⁵ or R⁴⁶ may be the same or different, X¹¹ represents the following formula (IV-a), and X¹² represents the following formula (IV-b):

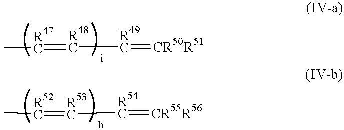

wherein i is an integer of from 0 to 2, h is an integer of from 0 to 2, each of R⁴⁷, R⁴⁸, R⁴⁹, R⁵⁰, R⁵¹, R⁵², R⁵³, R⁵⁴, R⁵⁵ and R⁵⁶ which may be the same or different, is a hydrogen atom, an alkyl group which may have a substituent, an alkoxy group which may have a substituent, an aryl group which may have a substituent, or a heterocyclic group which may have a substituent, and the pair of R⁵⁰ and R⁵¹ or the pair of R⁵⁵ and R⁵⁶, may be condensed to form a carbon ring group or a heterocyclic group, provided that when one of the pair of R⁵⁰ and R⁵¹ or the pair of R⁵⁵ and R⁵⁶, is a hydrogen atom or an alkyl group, the other is an aryl group or a heterocyclic group; when i=2, the plurality of R⁴⁷ and R⁴⁸ may respectively be the same or different; and when h=2, the plurality of R⁵² and R⁵³ may respectively be the same or different; and X¹¹ and X¹² may be the same or different.

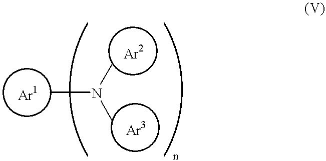

wherein Ar¹ is a benzene ring which may have a substituent, a naphthalene group which may have a substituent, or a biphenyl group which may have a substituent, each of Ar² and Ar³ which are independent of each other, is an aromatic ring which may have a substituent, and n is 1 or 2.

In the formula (V), Ar¹ is a benzene ring which may have a substituent, a naphthalene ring which may have a substituent, or a biphenyl ring which may have a substituent. Among them, a biphenyl ring which may have a substituent is preferred. As the substituent, a halogen atom, an alkyl group having a carbon number of at most 4, an alkoxy group having a carbon number of at most 3, an alkylthio group having a carbon number of at most 3, a cyano group or a nitro group, is preferred. Among them, a methyl group, a fluorine atom or a chlorine atom is further preferred. However, as the aromatic ring, a non-substituted one is most preferred.

Each of Ar² and Ar³ which are independent of each other, is an aromatic ring which may have a substituent, and the aromatic ring may be an aromatic hydrocarbon or an aromatic heterocyclic ring. Specifically, it may be a benzene ring, a naphthalene ring, a phenanthrene ring, an anthracene ring, a pyridine ring, a pyrrole ring, a furan ring, a thiophene ring, a benzofuran ring, a fluorene ring, or a benzothiophene ring. Among them, a benzene ring, a naphthalene ring or a thiophene ring is preferred.

Further, as the substituent on such an aromatic ring, a halogen atom, an alkyl group having a carbon number of at most 4, an alkoxy group having a carbon number of at most 3, an alkylthio group having a carbon number of at most 3, a cyano group, a nitro group or a substituent represented by the following formula (V-a) is preferred.

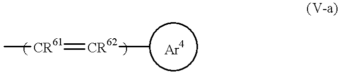

In the formula (V-a), Ar⁴ is a phenyl group which may have a substituent such as a halogen atom or an alkyl group. Each of R⁶¹ and R⁶² which are independent of each other, is a hydrogen atom or a methyl group, and n is 1, 2 or 3.

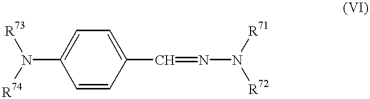

wherein each of R⁷¹, R⁷², R⁷³ and R⁷⁴ which are independent of one another, is an alkyl group which may have a substituent, an aryl group which may have a substituent, or an aralkyl group which may have a substituent.

The alkyl group is preferably a methyl group, an ethyl group, a propyl group or an isopropyl group; the aryl group is preferably a phenyl group, a naphthyl group, a thienyl group or a furyl group; and the aralkyl group is preferably a benzyl group, a phenethyl group, a thienylmethyl group or a furylmethyl group. Further, the substituent on the alkyl group is preferably a halogen atom, an alkoxy group having a carbon number of at most 3 or an alkylthio group having a carbon number of at most 3; and the substituent on the aryl group and the aralkyl group, is preferably a halogen atom, an alkyl group having a carbon number of at most 4, an alkoxy group having a carbon number of at most 3, an alkylthio group having a carbon number of at most 3, a cyano group or a nitro group.

Further, a compound having an atomic group represented by the following formula (VII), (VIII), (IX), (X) or (XI) is also preferably employed.

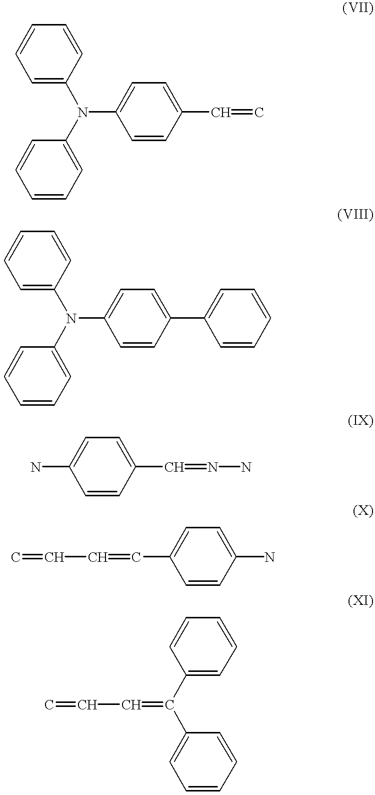

Specific examples of preferred charge transport agents will be shown below.

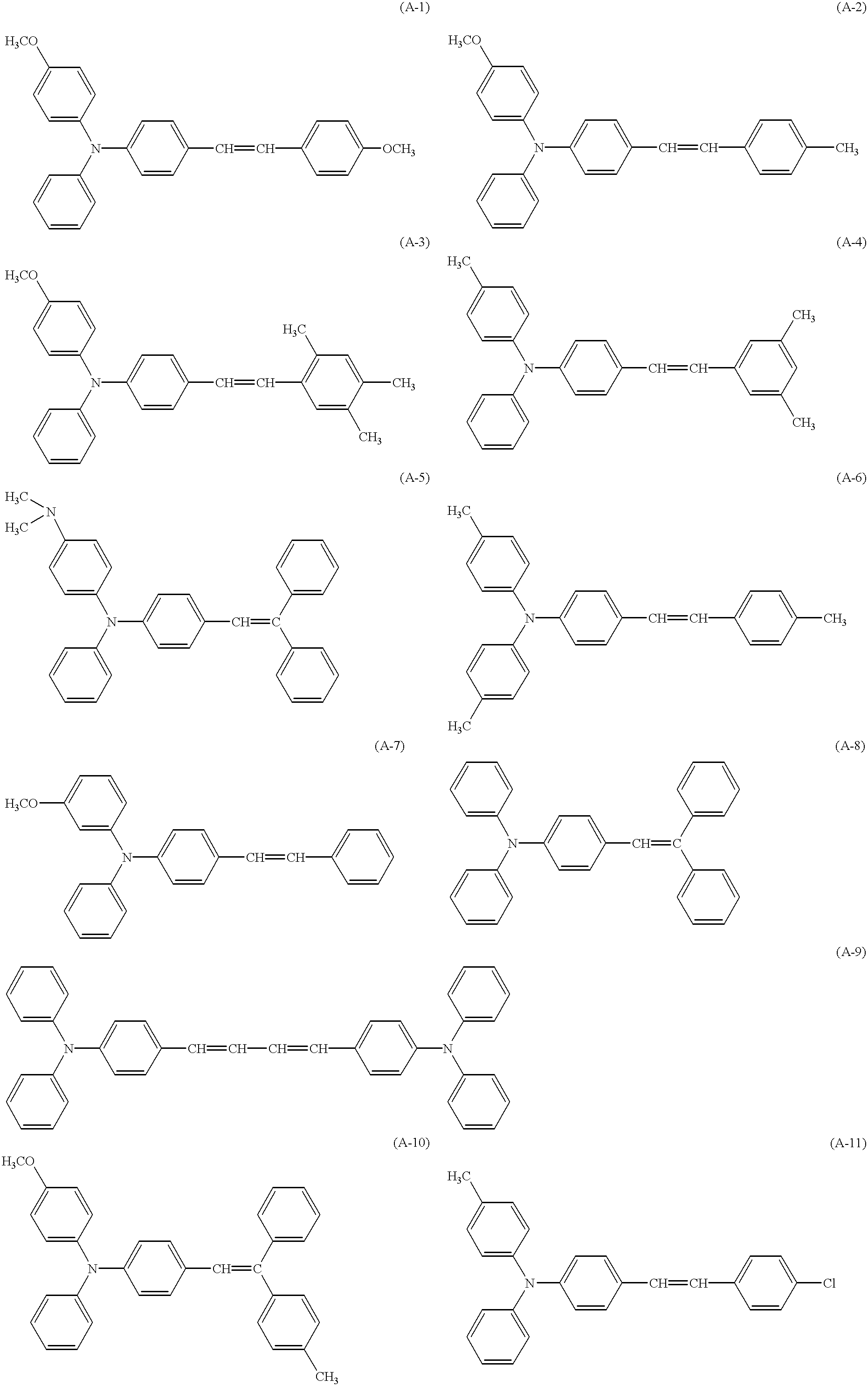

Further, in the charge transport layer, a binder polymer will be employed, as the case requires. The binder polymer is preferably a polymer which has good compatibility with the above charge transport agent and which is free from phase separation or crystallization of the carrier transport medium after formation of the coating film. Such a binder polymer may, for example, be a polymer or copolymer of a vinyl compound such as styrene, vinyl acetate, vinyl chloride, an acrylate, a methacrylate or butadiene, a polyvinyl acetal, a polycarbonate, a polyester, a polyarylate, a polysulfone, a polyphenylene oxide, a polyurethane, a cellulose ester, a cellulose ether, a phenoxy resin, a silicone resin or an epoxy resin. As a preferred binder resin, one containing a polycarbonate or a polyarylate is preferred although it depends also on the type of the charge transport agent.

As the polyarylate, one containing a structural unit of the following formula (XII), is preferred.

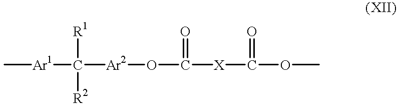

wherein each of Ar¹ and Ar² which are independent of each other, is a benzene ring which may have a substituent, X is a bivalent aliphatic hydrocarbon group which may have a substituent, a benzene ring which may have a substituent, a naphthalene group which may have a substituent, or a biphenyl group which may have a substituent, each of R¹ and R² which are independent of each other, is an aryl group which may have a substituent, an acyloxy group which may have a substituent, or an arylsulfoxy group which may have a substituent, or R¹ and R² may be bonded to each other to form a cyclic structure.

When the polyarylate having a structural unit of the formula (XII) is used as a binder, the abrasion resistance, the transfer property of the toner, and the release property will be excellent. Further, when this polyarylate is to be used as a binder for the charge transport layer, the charge transport agent is preferably A-10, A-13, A-14, B-1, B-2, B-3, B-4, B-5, C-4 or C-6.

In the formula (XII), each of Ar¹ and Ar² which are independent of each other, is a benzene ring which may have a substituent, wherein the substituent is preferably a halogen atom, a cyano group, a nitro group, a hydrocarbon group, a hydrocarbon group substituted by a halogen atom, an alkoxy group, an alkoxy group substituted by a halogen atom, or an alkylthio group. Among them, a methyl group, a cyclohexyl group, a phenyl group or an allyl group is further preferred. Further, the benzene ring which is unsubstituted, is also preferred.

Preferred as the substituent in X is a halogen atom, a cyano group, a nitro group, a hydrocarbon group, a hydrocarbon group substituted by a halogen atom, an alkoxy group, an alkoxy group substituted by a halogen atom, or an alkylthio group, and among them, a fluorine atom, a chlorine atom, a bromine atom, a methyl group, a methoxy group, a trifluoromethyl group or a trifluoromethoxy group, is further preferred. Further, X which is unsubstituted, is also preferred.

As the polycarbonate, one containing a structural unit represented by the following formula (XIII), (XIV), (XV) or (XVI) is preferred.

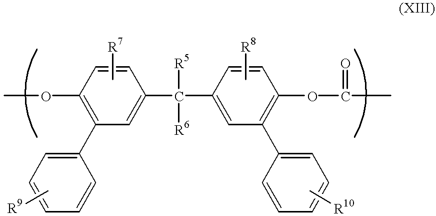

wherein each of R⁵ and R⁶ which are independent of each other, is a hydrogen atom, an alkyl group which may have a substituent, or a phenyl group, or R⁵ and R⁶ may bond to each other to have a cyclic structure, each of R⁷ and R⁸ which are independent of each other, is a hydrogen atom, an alkyl group which may have a substituent, or an aralkyl group, and each of R⁹ and R¹⁰ which are independent of each other, is a hydrogen atom or an alkyl group which may have a substituent.

When the polycarbonate having a structural unit of the formula (XIII) is employed, the abrasion resistance, the transfer property of the toner, and the release property will be particularly excellent.

In the formula (XIII), preferred as R⁵ and R⁶ is a hydrogen atom or an alkyl group having a carbon number of at most 8, and the substituent of the alkyl group may, for example, be a halogen atom, a cyano group, a nitro group, an alkoxy group having a carbon number of at most 5, or an alkylthio group having a carbon number of at most 5.

Further, preferred as R⁷ and R⁸ is a hydrogen atom, an alkyl group having a carbon number of at most 8, or an aralkyl group having a carbon number of at most 10, and the substituent of the alkyl group is the same as in the case of R³ and R⁴.

Further, preferred as R⁹ and R¹⁰ is a hydrogen atom, and an alkyl group having a carbon number of at most 8, and the substituent of the alkyl group is the same as in the case of R⁷ and R⁸.

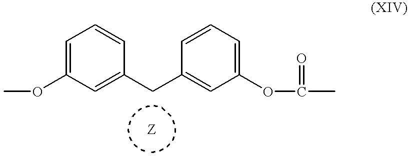

wherein Z is a C₅₋₈ aliphatic hydrocarbon ring which may have a substituent.

When the polycarbonate having a structural unit of the formula (XIV) is employed, the abrasion resistance, the transfer property of the toner and the release property will be particularly excellent, and such use is advantageous also from the viewpoint of the production. Further, when this polycarbonate is to be used as a binder for the charge transfer layer, the charge transfer agent is preferably A-8, A-10, A-13, A-14, B-1, B-2, B-3, B-4, B-5, C-1, C-4, C-6, D-2 or D3.

In the formula (XIV), preferred as Z is a cyclopentane ring, a cyclohexane ring, a cycloheptane ring, a dimethylcyclopentane ring, a methylcyclohexane ring, or a dimethylcyclohexane ring, and a cyclohexane ring is particularly preferred.

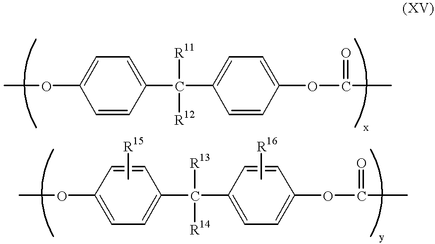

wherein each of R¹¹ and R¹² which are independent of each other, is a hydrogen atom or an alkyl group which may have a substituent, each of R¹³ and R¹⁴ which is independent of each other, is a hydrogen atom or an alkyl group which may have a substituent, or R¹³ and R¹⁴ may be bonded to each other to have a cyclic structure, each of R¹⁵ and R¹⁶ which are independent of each other, is a hydrogen atom or an alkyl group which may have a substituent, provided that all of R¹¹ and R¹⁴ are not the same groups, and both R¹⁵ and R¹⁶ are not hydrogen atoms, and x:y=1:9 to 9:1.

When the polycarbonate having a structural unit of the formula (XV) is employed, the electrical characteristics will be particularly excellent, and such a use is advantageous also from the viewpoint that it has a solubility in a wide range of solvents. Further, when this polycarbonate is to be used as a binder of the charge transport layer, the charge transport agent is preferably A-8, A-10, A-13, A-14, B-1, B-2, B-3, B-4, B-5, C-1, C-4, C-6, D-2 or D-3.

In the formula (XV), preferred as R¹¹ and R¹², is a hydrogen atom or an alkyl group having a carbon number of at most 8, and the substituent for the alkyl group is preferably one having high reactivity at a room temperature under atmospheric pressure, and specifically, it may, for example, be a halogen atom, a cyano group, a nitro group, an alkoxy group having a carbon number of at most 5, or an alkylthio group having a carbon number of at most 5.

Further, preferred as R¹³ and R¹⁴, is a hydrogen atom or an alkyl group having a carbon number of at most 8, and the substituent of the alkyl group is the same as in the case of R¹¹ and R¹².

Further, preferred as R¹⁵ and R¹⁶, is a hydrogen atom or an alkyl group having a carbon number of at most 8, and the substituent of the alkyl group is the same as in the case of R¹¹ and R¹².

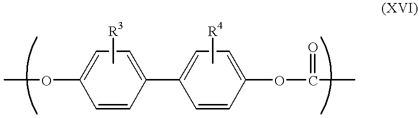

In the formula (XVI), each of R³ and R⁴ which are independent of each other, is a hydrogen atom, an alkyl group which may have a substituent, or a phenyl group.

When the polycarbonate having a structural unit of the formula (XVI) is employed, the abrasion resistance, the transfer property of the toner, and the release property will be particularly excellent.

In the formula (XVI), preferred as R³ and R⁴, is a hydrogen atom or an alkyl group having a carbon number of at most 8, and the substituent of the alkyl group is preferably one having a reactivity being not so high at room temperature under atmospheric pressure. Specifically, it may, for example, be a halogen atom, a cyano group, a nitro group, an alkoxy group having a carbon number of at most 5, or an alkylthio group having a carbon number of at most 5.

When the charge transport agent is a polymer compound, a binder polymer may not be employed, but it may be incorporated for the purpose of improving the flexibility. In the case of a low molecular weight compound, a binder polymer is employed for the film-forming property, and it is used usually in an amount of from 50 to 1,000 parts by weight, preferably from 100 to 500 parts by weight, per 100 parts by weight of the charge transfer agent. To the charge transfer layer, various additives may further be incorporated in order to improve the durability or the mechanical strength of the coating film. Such additives may, for example, be well known plasticizers, and various stabilizers, fluidity-imparting agents or cross-linking agents.

The thickness of the charge transport layer is usually from 10 to 60 μm, preferably from 10 to 45 μm, more preferably from 27 to 40 μm.

The above-mentioned undercoating layer, the charge generation layer and the charge transport layer may be formed by a spray coating method, a spiral coating method, a ring coating method or a dip coating method, following dissolution or dispersion in a suitable solvent depending upon the binder or the blend components used.

In the case of the dip coating method, the coating fluid is prepared so that the total solid content concentration is preferably from 25 to 40%, and the viscosity is preferably from 50 to 300 centipoise, more preferably from 100 to 200 centipoise.

As the drying method after the coating, a hot air dryer, a vapor dryer, an infrared ray dryer or a far infrared ray dryer may, for example, be employed.

Now, as the exposure apparatus to carry out exposure to form a latent image in the photoreceptor, an apparatus to carry out digital exposure may be employed. However, taking into consideration the light absorption of the above-described Y-type oxytitanium phthalocyanine, it is preferred to employ an exposure device which emits a laser beam of from 500 to 850 nm. More specifically, it is preferred to employ an exposure device which emits a laser beam in the vicinity of 532 nm, in the vicinity of 635 nm, in the vicinity of 650 nm, in the vicinity of 780 nm or in the vicinity of 830 nm.

In a case where an image is formed by using the above-described toner and the photoreceptor, when a toner having Dv of from 3 to 8 μm and a Dv/Dn value of from 1.0 to 1.3, is employed, the uniformity in deposition of the toner on the latent image will be good, whereby a latent image having a high gradation and high resolution can be accurately reproduced.

Further, such a toner has a uniform particle shape, whereby localization of electrification in a particle attributable to the difference in the particle shapes, scarcely takes place. Consequently, every particle will attach to the photoreceptor with substantially a uniform force, whereby the latent image is believed to be accurately reproduced.

Yet, by using the above-described oxytitanium phthalocyanine as the charge generation material for the photoreceptor, the photoreceptor will have high sensitivity and high y characteristics, and this photoreceptor shows an adequate photoresponse, whereby even if the number of dots is increased to a level of at least 600 dpi and the exposure time for each dot is shortened, development can still be made with a sufficient toner density. Further, the present invention can effectively be applied to an image-forming apparatus of a smaller size and having high speed and high resolution.

Accordingly, the image-forming method of the present invention is particularly effective in the case of forming an image having a resolution of at least 600 dpi or even at least 1,200 dpi, and is particularly effective in the case where the rotational speed of the electrophotographic photoreceptor is 1.5 times/sec, and it is particularly effective in the case where the electrophotographic photoreceptor is drum having an inner diameter of at most 35 mm.

Now, the present invention will be described in further detail with reference to Examples. However, it should be understood that the present invention is by no means restricted to such specific Examples.

In the following Examples, “parts” means “parts by weight”. Further, the average particle diameter, the weight average molecular weight, the glass transition temperature (Tg), and the 50% circularity were measured by the following methods, respectively.

Volume average particle diameter, number average particle diameter: Measured by LA-500, manufactured by Horiba Ltd., Microtrac UPA (ultra particle analyzer), manufactured by Nikkiso K.K. and by Coulter Counter Multisizer II model (referred to simply as Coulter Counter), manufactured by Coulter Inc.

Weight average molecular weight (Mw): Measured by gel permeation chromatography (GPC) (apparatus: GPC apparatus, manufactured by TOSOH CORPORATION, HLC-8020, column: PL-gel Mixed-B 10 μ, manufactured by Polymer Laboratory Co., solvent: THF, sample concentration: 0.1 wt %, calibration curve: standard polystyrene).

Glass transition temperature (Tg): Measured by DSC7, manufactured by Perkin-Elmer Corp. (the temperature was raised from 30° C. to 100° C. for 7 minutes, and rapidly cooled from 100° C. to −20° C., and raised from −20° C. to 100° C. in 12 minutes, and the Tg value observed during the second temperature rise was taken.)

Number of particles of from 0.6 to 2.12 μm: Measured by flow type particle image analyzing apparatus FPIA-2000, manufactured by Sysmex Corporation.

Proportion of particles having particle diameters of 55% or less, or 40% or less of the volume average particle diameter: Measured by the Coulter Counter.

50% circularity: The toner was measured by the flow type particle image analyzing apparatus FPIA-2000, manufactured by Sysmex Corporation, and the circularity corresponding to the cumulative particle size value at 50% of the value obtained by the following formula, was taken.

Circularity=Peripheral length of a circle having the same area as the area of the projected image of a particle/Peripheral length of the projected image of the particle

### EXAMPLES A1 TO A3 AND COMPARATIVE EXAMPLES B1 TO B3

Preparation of Toner for Development-1 (TA1)

Wax Dispersion-1

68.33 parts of demineralized water, 30 parts of a ester mixture mainly composed of a stearic acid ester of pentaerythritol (Unistar H-476, manufactured by Nippon Oil & Fat) and 1.67 parts of sodium dodecylbenzenesulfonate (Neogen SC, manufactured by Daiichi Pharmaceutical Co., Ltd., active ingredient: 66%) were mixed and emulsified by application of high pressure shearing at 90° C. to obtain a dispersion of fine particles of ester wax. The average particle diameter of the fine particles of ester wax as measured by LA-500, was 340 nm.

Polymer Primary Particle Dispersion-1

Into a reactor (capacity: 60 l, inner diameter: 400 mm) equipped with a stirrer (three vanes), a heating and cooling device, a concentrating device and a device for charging the respective materials and agents, 28 parts of the wax dispersion-1, 1.2 parts of a 15% Neogen SC aqueous solution and 393 parts of demineralized water were charged and heated to 90° C. in a nitrogen stream, and 1.6 parts of a 8% hydrogen peroxide aqueous solution and 1.6 parts of a 8% ascorbic acid aqueous solution were added thereto.

Then, a mixture of the following monomers/emulsifier aqueous solution was added over a period of 5 hours from the initiation of the polymerization and an initiator aqueous solution over a period of 6 hours from the initiation of the polymerization, and the system was further maintained for 30 minutes.

| Monomers | | |
|---|---|---|
| Styrene | 79 | parts (5,530 g) |
| Butyl acrylate | 21 | parts |
| Acrylic acid | 3 | parts |
| Bromotrichloromethane | 0.45 | part |
| 2-Mercaptoethanol | 0.01 | part |
| Heaxanediol diacrylate | 0.9 | part |
| Emulsifier aqueous solution | | |
| 15% Neogen SC aqueous solution | 1 | part |
| Demineralized water | 25 | parts |
| Initiator aqueous solution | | |
| 3% Hydrogen peroxide aqueous solution | 9 | parts |
| 8% Ascorbic acid aqueous solution | 9 | parts |

After completion of the polymerization reaction, the reaction solution was cooled to obtain a milky white polymer dispersion. The weight average molecular weight of the THF soluble content of the polymer was 127,000, and the average particle size as measured by UPA was 220 nm. Tg was not clear.

Resin Fine Particle Dispersion-1

Into a reactor (capacity: 60 l, inner diameter: 400 mm) equipped with a stirrer (three vanes), a heating and cooling device, a concentrating device and a device for charging various materials and agents, 5 parts of a 15% Neogen SC aqueous solution and 372 parts of demineralized water were charged and heated to 90° C. in a nitrogen stream, and 1.6 parts of a 8% hydrogen peroxide aqueous solution and 1.6 parts of a 8% ascorbic acid aqueous solution were added thereto.

Then, a mixture of the following monomers/emulsifier aqueous solution was added over a period of 5 hours from the initiation of the polymerization, and an initiator aqueous solution over a period of 6 hours from the initiation of the polymerization, and the system was maintained for further 30 minutes.

| Monomers | | |
|---|---|---|
| Styrene | 88 | parts (6,160 g) |
| Butyl acrylate | 12 | parts |
| Acrylic acid | 2 | parts |
| Bromotrichloromethane | 0.5 | part |
| 2-Mercaptoethanol | 0.01 | part |
| Heaxanediol diacrylate | 0.4 | part |
| Emulsifier aqueous solution | | |
| 15% Neogen SC aqueous solution | 2.5 | part |
| Demineralized water | 24 | parts |
| Initiator aqueous solution | | |
| 8% Hydrogen peroxide aqueous solution | 9 | parts |
| 8% Ascorbic acid aqueous solution | 9 | parts |

After completion of the polymerization reaction, the reaction solution was cooled to obtain a milky white polymer dispersion. The weight average molecular weight of the THF soluble content of the polymer was 54,000, the average particle size as measured by UPA was 83 nm, and Tg was 85° C.

Colorant Fine Particle Dispersion-1

An aqueous dispersion of pigment blue 15:3 (EP-700 Blue GA, manufactured by Dainichiseika Color & Chemicals Mfg. Co., Ltd., solid content: 35%) the average particle size as measured by UPA was 150 nm.

Preparation of Toner for Development-1

Polymer primary particle dispersion-1

103 parts (2,773 g as solid content)

Resin fine particle dispersion-1

5 parts (as solid content)

Colorant fine particle dispersion-1

6.7 parts (as solid content)

15% Neogen SC aqueous solution

0.5 part (as solid content)

Using the above-mentioned various components, a toner was prepared in the following manner.

Into a reactor (capacity: 60 l, anchor vanes provided with a baffle), the polymer primary particle dispersion and the 15% Neogen SC aqueous solution were charged and uniformly mixed, and then the colorant fine particle dispersion was added and uniformly mixed. While stirring the obtained mixed dispersion, an aqueous aluminum sulfate solution was dropwise added (0.6 part as solid content). Then, with stirring, the temperature was raised to 50° C. over a period of 25 minutes, maintained for an hour, then further raised to 60° C. over a period of 15 minutes and then maintained for 1 hour and 35 minutes. The resin fine particle dispersion and an aqueous aluminum sulfate solution (0.07 part as solid content) were added in this order, and the temperature was raised to 62° C. over a period of 5 minutes and maintained for 30 minutes. The 15% Neogen SC aqueous solution (3 parts as solid content) was added thereto, and then the temperature was raised to 96° C. over a period of 50 minutes and maintained for 3 hours. Then, the mixture was cooled and subjected to filtration, washing with water and drying to obtain a toner.

To 100 parts of this toner, 0.6 part of silica having hydrophobic surface treatment applied, was mixed and stirred to obtain a toner for development (TA1).

Evaluation of Toner-1

The volume average particle diameter of the toner for development (TA1) by the Coulter Counter, was 7.2 μm, the proportion of particles having particle diameters of not more than 5 μm was 2.5%, the proportion of particles of 15 μm or larger was 0.8%, the proportion of the number of particles having particle diameters of from 0.6 to 2.12 μm was 0.39%, the proportion of particles having particle diameters of 55% or less of the volume average particle diameter was 0.39 vol % and 2.12 number %, and the proportion of particles having particle diameters of 40% or less of the volume average particle diameter was 1.37 number %. Further, Dv/Dn=1.13, and the 50% circularity was 0.95.

Preparation of Toner for Development-2 (TA2) Wax Dispersion-2

68.33 parts of demineralized water, 30 parts of a mixture comprising an ester mixture containing behenyl behenate as the main component (Unistar-M2222SL, manufactured by Nippon Oil & Fat Co., Ltd.) and an ester mixture containing stearyl stearate as the main component (Unister M9676, manufactured by Nippon Oil & Fat Co., Ltd.) in a ratio of 7:3 and 1.67 parts of sodium dodecylbenzenesulfonate (Neogen SC, manufactured by Daiichi Pharmaceutical Co., Ltd., active ingredient: 66%) were mixed and emulsified by application of high pressure shearing at 90° C. to obtain a dispersion of fine particles of ester wax. The average particle diameter of the fine particles of ester wax as measured by LA-500, was 340 nm.

Polymer Primary Particle Dispersion-2

Into a reactor (capacity: 60 l, inner diameter: 400 mm) equipped with a stirrer (three vanes), a heating and cooling device, a concentrating device and a device for charging various materials and agents, 28 parts of the wax dispersion-2, 1.2 parts of the 15% Neogen SC aqueous solution and 393 parts of demineralized water were charged and heated to 90° C. in a nitrogen stream, and 1.6 parts of a 8% hydrogen peroxide aqueous solution and 1.6 parts of a 8% ascorbic acid aqueous solution were added.

Then, a mixture of the following monomers/emulsifier aqueous solution was added over a period of 5 hours from the initiation of the polymerization and an initiator aqueous solution over a period of 6 hours from the initiation of the polymerization, and the system was further maintained for further 30 minutes.

| Monomers | | |
|---|---|---|
| Styrene | 79 | parts |
| Butyl acrylate | 21 | parts |
| Acrylic acid | 3 | parts |
| Bromotrichloromethane | 0.45 | part |
| 2-Mercaptoethanol | 0.01 | part |
| Heaxanediol diacrylate | 0.9 | part |
| Emulsifier aqueous solution | | |
| 15% Neogen SC aqueous solution | 1 | part |
| Demineralized water | 25 | parts |
| Initiator aqueous solution | | |
| 8% Hydrogen peroxide aqueous solution | 9 | parts |
| 8% Ascorbic acid aqueous solution | 9 | parts |

After completion of the polymerization reaction, the reaction solution was cooled to obtain a milky white polymer dispersion. The weight average molecular weight of the THF soluble content of the polymer was 148,000, the average particle diameter as measured by UPA was 207 nm, and Tg was 55° C.

Resin Fine Particle Dispersion-2

The same one as the resin fine particle dispersion-1 was employed.

Colorant Fine Particle Dispersion-2

20 Parts of C.I. pigment yellow 74, 7 parts of polyoxyethylene alkyl phenyl ether and 73 parts of demineralized water were dispersed by a sand grinder mill to obtain a colorant fine particle dispersion. The average particle diameter as measured by UPA was 211 nm.

Charge Control Agent Fine Particle Dispersion-2

20 Parts of 4,4′-methylenebis[2-[N-(4-chlorophenyl)amide]-3-hydroxynaphthalene], 4 parts of an alkylnaphthalene sulfonate and 76 parts of demineralized water were dispersed by a sand grinder mill to obtain a charge control agent fine particle dispersion. The average particle diameter as measured by UPA was 200 nm.

Preparation of Toner for Development-2

Polymer primary particle dispersion-2

105 parts (as solid content)

Resin fine particle dispersion-1

5 parts (as solid content)

Colorant fine particle dispersion-2

6.7 parts (as solid content)

Charge control agent fine particle dispersion-2

2 parts (as solid content)

Using the above various components, a toner was prepared in the following manner.

Into a reactor (capacity: 1 l, anchor vanes equipped with a baffle), the polymer primary particle dispersion and the colorant fine particle dispersion were charged and uniformly mixed. While stirring the obtained mixed dispersion, an aqueous aluminum sulfate solution was dropwise added (0.6 part as solid content). Then, with stirring, the temperature was raised to 51° C. over a period of 25 minutes, maintained for 1 hour, further raised to 59° C. over a period of 8 minutes and maintained for 40 minutes. The charge control agent fine particle dispersion, the resin fine particle dispersion and an aqueous aluminum sulfate solution (0.07 part as solid content) were added in this order, and the temperature was raised to 61° C. over a period of 15 minutes and maintained for 30 minutes. After adding the 15% Neogen SC aqueous solution (3.8 parts as solid content), the temperature was raised to 96° C. over a period of 30 minutes and maintained for 4 hours. Then, the mixture was cooled and subjected to filtration, washing with water and drying to obtain a toner.

To 100 parts of this toner, 0.6 part of silica having hydrophobic surface treatment applied, was mixed and stirred to obtain a toner for development (TA2).

Evaluation of Toner-2

The volume average particle diameter of the toner for development (TA2) by the Coulter Counter was 7.5 μm, the proportion of particles having particle sizes of not more than 5 μm was 1.6%, the proportion of particles of 15 μm or larger was 0.7%, the proportion of the number of particles having particle diameters of from 0.6 to 2.12 μm was 0.46%, the proportion of particles having particle diameters of 55% or less of the volume average particle diameter was 0.26 vol % and 2.8 number %, and the proportion of particles having particle diameters of 40% or less of the volume average particle diameter was 1.29 number %. Further, Dv/Dn=1.14, and the 50% circularity was 0.96.

Preparation of Toner for Development-3 (TA3)

Wax Dispersion-3

The one prepared in the same manner as wax dispersion-2, was used. The average particle diameter of the fine particles of ester wax as measured by LA-500, was 340 nm.

Polymer Primary Particle Dispersion-3

One prepared in the same manner as the polymer primary particle dispersion-2 employing the wax fine particle dispersion-3, was used.

The weight average molecular weight of the THF-soluble content of the polymer was 119,000, the average particle size as measured by UPA was 189 nm, and Tg was 57° C.

Resin Fine Particle Dispersion-3

The same one as the resin fine particle dispersion-1 was used.

Colorant Fine Particle Dispersion-3

20 Parts of C.I. pigment red 238 (compound of the following formula (A)), 2.5 parts of an alkylbenzene sulfonate and 77.5 parts of demineralized water were dispersed by a sand grinder mill to obtain a colorant fine particle dispersion. The average particle diameter as measured by UPA was 181 nm.

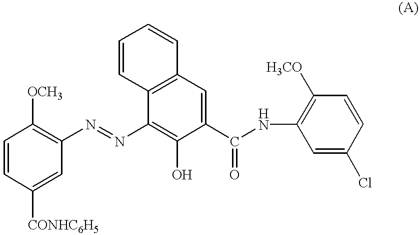

Charge Control Agent Fine Particle Dispersion-3

The same one as the charge control agent fine particle dispersion-2 was used.

Preparation of Toner for Development-3

Polymer primary particle dispersion-3

104 parts (as solid content)

Resin fine particle dispersion-1

6 parts (as solid content)

Colorant fine particle dispersion-3

6.7 parts (as solid content)

Charge control agent fine particle dispersion-2

2 parts (as solid content)

15% Neogen SC aqueous solution

0.65 part (as solid content)

Using the above various components, a toner was prepared in the following manner.

In a reactor (capacity: 1 l, anchor vanes provided with a baffle), the polymer primary particle dispersion and the 15% Neogen SC aqueous solution were charged and uniformly mixed, and then the colorant fine particle dispersion was added and uniformly mixed. While stirring the obtained mixed dispersion, an aqueous aluminum sulfate solution was dropwise added (0.8 part as solid content). Then, with stirring, the temperature was raised to 51° C. over a period of 15 minutes, then maintained for 1 hour, further raised to 59° C. over a period of 6 minutes and maintained for 20 minutes. The charge control agent fine particle dispersion, the resin fine particle dispersion and an aqueous aluminum sulfate solution (0.09 part as solid content) were added in this order, and maintained at 59° C. for 20 minutes. After adding the 15% Neogen SC aqueous solution (3.7 parts as solid content), the temperature was raised to 95° C. over a period of 25 minutes, then the 15% Neogen SC aqueous solution (0.7 part as solid content) was further added and maintained for 3.5 hours. Then, the mixture was cooled and subjected to filtration, washing with water and drying to obtain a toner.

To 100 parts of this toner, 0.6 part of silica having hydrophobic surface treatment applied, was mixed and stirred to obtain a toner for development (TA3).

Evaluation of Toner-3

The volume average particle diameter of the toner for development (TA3) by the Coulter Counter, was 7.8 μm, the proportion of particles having particle diameters of not more than 5 μm was 2.1%, the proportion of particles of 15 μm or larger was 2.1%, the proportion of the number of particles having particle diameters of from 0.6 to 2.12 μm was 0.80%, the proportion of particles having particle diameters of 55% or less of the volume average particle diameter was 0.51 vol % and the proportion of particles having particle diameters of 40% or less of the volume average particle diameter was 1.85 number %. Further, Dv/Dn=1.15, and the 50% circularity was 0.97.

Preparation Example of Photoreceptor-1

Alumite Layer

An aluminum cylinder having a diameter of 30 mm, a length of 340 mm and a wall thickness of 1 mm and having the surface mirror-finished, was subjected to degreasing and washing in an aqueous solution containing 30 g/l of a degreasing agent NC-#30 (manufactured by Kizai K.K.) at 60° C. for 5 minutes. Then, washing with water was carried out, and then it was immersed in 7% nitric acid at 25° C. for 1 minute. After further washing with water, anodic oxidation was carried out in a 180 g/l of sulfuric acid electrolyte (dissolved aluminum concentration: 7 g/l) at a current density of 1.2 A/dm², to form an anodic coating having an average thickness of 6 μm. Then, after washing with water, it was immersed in an aqueous solution containing 10 g/l of a high temperature sealing agent top seal DX-500 (manufactured by Okuno Chemical Industries Co., Ltd.) containing nickel acetate as the main component, at 95° C. for 30 minutes. Then, washing with water was carried out, and then the entire coating surface was rubbed three times in reciprocation by means of a polyester sponge to carry out washing. Then, it was washed with water and dried.

As titanium oxide, TTO-55N, tradename, manufactured by Ishihara Sangyo K.K. (crystal type: rutile, primary particle diameter: 0.03 to 0.05 μm) and a mixed alcohol (methanol/1-propanol=70/30) were dispersed for 16 hours in a ball mill. The titanium oxide dispersion thereby obtained was added to a solution of the following polyamide resin (PA-1) in a mixed alcohol (methanol/1-propanol=70/30). A dispersion finally having a titanium oxide/nylon ratio of 1/1 (weight ratio) and a solid content concentration of 16%, was prepared, and this dispersion was used as the dispersion for the undercoating layer.

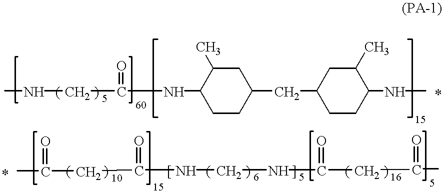

The above drum (the aluminum cylinder) was dip-coated with the above dispersion for the undercoating layer to form an undercoating layer so that the dried layer thickness would be 0.75 μm.

Charge Generation Layer

Preparation of β-type Oxytitanium Phthalocyanine (β-type TiOPc)

97.5 g of phthalodinitrile was added to 750 ml of α-chloronaphthalene, and then, 22 ml of titanium tetrachloride was dropwise added in a nitrogen atmosphere. After the dropwise addition, the temperature was raised, and the mixture was reacted at a temperature of from 200 to 220° C. for 3 hours, whereupon it was left to cool, then filtered while it was still hot at a temperature of from 100 to 130° C., and washed with 200 ml of α-chloronaphthalene heated to 100° C. Further, hot washing treatment with 200 ml of N-methylpyrrolidone (100° C., 1 hour) was carried out three times. Then, washing with 300 ml of methanol was carried out at room temperature, and hot washing with 500 ml of methanol for 1 hour, was carried out three times. The X-ray diffraction spectrum of oxytitanium phthalocyanine thus obtained, is shown in FIG. 1. As is evident from FIG. 1, no substantial peak is observed at a Bragg angle (2θ±0.2°) of from 4° to 8°, and distinct diffraction peaks are observed at 9.3°, 10.6°, 13.2°, 15.1°, 15.7°, 16.1°, 20.8°, 23.3°, 26.3° and 27.1°. Among them, the peak at 26.3° is the strongest,

Preparation of Y-type Oxytitanium Phthalocyanine (Y-type TiOPc)

The β-type oxytitanium phthalocyanine obtained as described above, was subjected to pulverization treatment in a sand grind mill for 20 hours, then put into a suspension comprising 400 ml of water and 40 ml of orthodichlorobenzene and subjected to heat treatment at 60° C. for 1 hour. According to the X-ray diffraction (Bragg-Brentano concentration method) of oxytitanium phthalocyanine thus obtained, the maximum sharp peak was observed at a Bragg angle (2θ±0.2°) of 27.3°.

Further, the Y-type oxytitanium phthalocyanine thus obtained was subjected to transmission method X-ray diffraction by 1.2085 Å using a capillary as the sample holder, whereby diffraction peaks were observed at Bragg angles (2θ±0.2°) of 21.30 (100) (the number in the bracket indicates the relative intensity based on the peak intensity at 21.3° being 100), 18.9° (13), 14.1° (12), 11.8° (14), 11.1° (11), 9.2° (11), 7.6° (36), 7.4° (25) and 5.8° (8).

Further, the measuring apparatus was a multiple detector powder X-ray diffraction apparatus, and the details of the apparatus are disclosed in “Emitted Light Powder Diffraction Test Station (BL-4B) Designed Report, (1995), KEK Report 94-11” published by High Energy Physics Research Center.

The measuring conditions were such that the step angle was 0.0050, 4.5 seconds/step, and the wavelength for calculation of the d value=1.2085 Å.

Preparation and Coating of Coating Fluid for Charge Generation Layer

10 Parts of the Y-type TiOPc obtained in the above Preparation Example, was added to 150 parts by weight of 4-methoxy-4-methylpentanone-2, followed by pulverization dispersion treatment by a sand grind mill. Further, 100 parts of a 1,2-dimethoxyethane solution containing 5% of polyvinylbutyral (Denka Butyral #6000C, tradename, manufactured by Denki Kagaku Kogyo K.K.) and 100 parts of a 1,2-dimethoxyethane solution containing 5% of a phenoxy resin (PKHH, tradename, manufactured by Union Carbide), were mixed to obtain a binder solution. To the 160 parts by weight of the pigment dispersion previously prepared, 100 parts by weight of the binder solution and a suitable amount of 1,2-dimethoxyethane, were added to obtain a dispersion finally having a solid content concentration of 4.0%.

The dispersion thus obtained was further coated by dip coating on the aluminum drum coated with the above undercoating layer, to form a charge generation layer having a thickness of 0.2 μm.

Charge Transport Layer

Then, 45 parts of the following charge transport material (TAPC), 100 parts of a polycarbonate resin represented by the following structural formula (m:n=51:49, the viscosity average molecular weight: 30,000), 16 parts of 4-methyl-2,6-di-tert-butylphenol and 0.03 part of silicone oil (KF-96, manufactured by Shin-Etsu Silicone K.K.) were dissolved in a mixed solvent comprising 170 parts of dioxane and 400 parts of tetrahydrofuran, to obtain a coating fluid. This coating fluid was further coated by dip coating on the aluminum drum having the above undercoating layer and the charge generation layer coated, to form a charge-transport layer so that the layer thickness after drying at 125° C. for 20 minutes would be 20 μm.

This will be referred to as photoreceptor “PC-Al”.

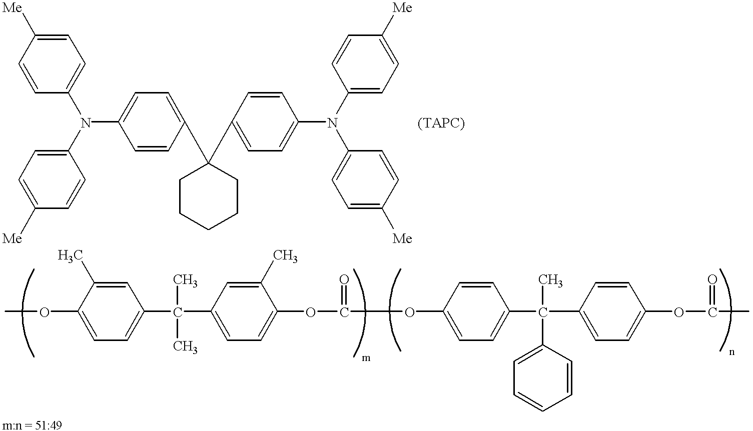

Preparation Example of Photoreceptor-2

The alumite layer, the undercoating layer and the charge generation layer were formed in the same manner as in the above-mentioned preparation of photoreceptor-1.

Charge Transport Layer

Then, 60 parts of a charge transport material having a structural formula of (D-2), 100 parts of a polycarbonate resin represented by the following structural formula, 6 parts of 4-methyl-2,6-di-tert-butylphenol and 0.03 part of silicone oil (KF-96, manufactured by Shin-Etsu Silicone) were dissolved in a mixed solvent comprising 170 parts of dioxane and 400 parts of tetrahydrofuran, to obtain a coating fluid. This coating fluid was further coated by dip coating on the aluminum drum having the above undercoating layer and the charge generation layer coated, to form a charge transport layer so that the layer thickness after drying at 125° C. for 20 minutes would be 20 μm.

This is referred to as photoreceptor “PC-A2”.

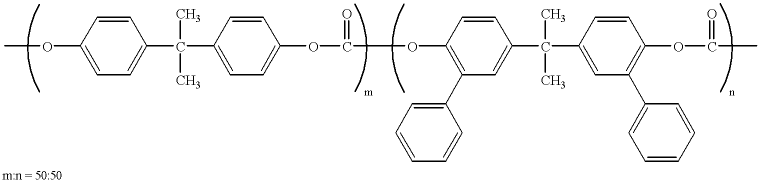

Preparation Example of Photoreceptor-3

The alumite layer, the undercoating layer and the charge generation layer were formed in the same manner as in the above Preparation Example of photoreceptor-1.

Charge Transport Layer

60 Parts of a charge transport material of the structural formula (B-5), 100 parts of a polyester represented by the following structural formulas [a copolymer polyester resin containing (P-1) and (M-1) in a ratio of 7:3 (viscosity average molecular weight: 33,000)], 8 parts of 4-methyl-2,6-di-tert-butylphenol and 0.03 part of silicone oil as a leveling agent (KF-96, manufactured by Shin-Etsu Silicone) were dissolved in a mixed solvent comprising 170 parts of dioxane and 400 parts of tetrahydrofuran, to obtain a coating fluid. This coating fluid was further coated by dip coating on the aluminum drum having the above undercoating layer and the charge generation layer formed, to form a charge transport layer so that the thickness after drying at 125° C. for 20 minutes would be 20 μm.

This is referred to as photoreceptor “PC-A3”.

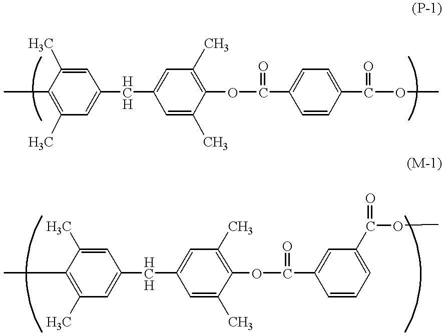

Preparation Example of Photoreceptor-4

The alumite layer was prepared in the same manner as the above preparation of photoreceptor-1. Without forming an underlayer, a charge generation layer was formed on the alumite layer in the same manner as in the above preparation of photoreceptor-1.

Charge Transport Layer

60 Parts of a charge transport material of the structural formula (B-5), 100 parts of a polycarbonate resin represented by the following structural formula (m:n=51:49, viscosity average molecular weight: 31,400), 8 parts of 4-methyl-2,6-di-tert-butylphenol and 0.03 part of silicone oil (KF-96, manufactured by Shin-Etsu Silicone) were dissolved in a mixed solvent comprising 170 parts of dioxane and 400 parts of tetrahydrofuran, to obtain a coating fluid. This coating fluid was further coated by dip coating on the aluminum drum having the above undercoating layer and the charge generation layer formed, to form a charge transport layer so that the layer thickness after drying at 125° C. for 20 minutes would be 20 μm.

This is referred to as photoreceptor “PC-A4”.

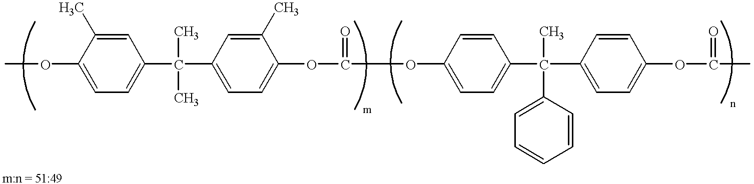

Preparation Example of Photoreceptor-5

In the same manner as in preparation of photoreceptor-4, a charge generation layer was formed on the alumite layer.

Charge Transport Layer

35 Parts of a charge transport material of the structural formula (A-13), 35 parts of a charge transport material of (B-2), 100 parts of a polycarbonate resin represented by the following formula (Eupiron Co. Z-400, manufactured by Mitsubishi Gas Chemical Co.), 8 parts of 4-methyl-2,6-di-tert-butylphenol and 0.03 part of silicone oil as a leveling agent (KF-96, manufactured by Shin-Etsu Silicone) were dissolved in a mixed solvent comprising 110 parts of toluene and 450 parts of tetrahydrofuran, to obtain a coating fluid. This coating fluid was coated further by dip coating on the aluminum drum having the above undercoating layer and the charge generation layer formed, to form a charge transport layer so that the layer thickness after drying at 125° C. for 20 minutes would be about 20 μm.

This is referred to as photoreceptor “PC-A5”.

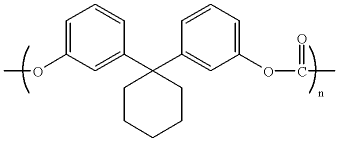

### EXAMPLE A1

A cyan toner (TA1) was put into a development tank of a color laser printer Color Pagepresto N4-612II, manufactured by Casio Co., and a photoreceptor (PC-A1: using Y-type oxytitanium phthalocyanine) was mounted, whereupon fine line images were formed in the longitudinal and transverse directions with two dots on and two dots off at an exposure density of 600 dpi.

### COMPARATIVE EXAMPLE B1

Fine line images were formed in the same manner as in Example A1 except that as the toner, a cyan toner of pure N4-612II (this will be referred to as toner (TB1); prepared by a kneading/pulverization method) was used.

Further, the volume average particle diameter (Dv) of TB1 was 9.10 μm, Dv/Dn=1.24, the 50% circularity was 0.93, and the proportion of the number of particles having particle diameters of from 0.6 to 2.12 μm was 4.8%.

The fine line images obtained in Example A1 and Comparative Example B1 were read by a digital microscope manufactured by Keyence and subjected to image analysis by a Winloop software of Mitsuya Shoji, and the image density was obtained. Further, the value of the image density was raw data calculated by the above software by the image analysis, and the larger the value, the higher the image density.

FIG. 3 is a graph showing the results of the image analysis of the fine image drawn in the longitudinal direction, and FIG. 4 is a graph showing the results of the image analysis of the fine line image drawn in the transverse direction.

In FIG. 3 (longitudinal direction), in a case where either toner TA1 or TB1 is used, substantially the same mountain/valley shape is obtained, and the resolution is also substantially the same, but in FIG. 4 (transverse direction), when TA1 is used, the mountain/valley shape is clearly reproduced, and it has been found that high resolution is shown.

### REFERENCE EXAMPLE

The photoreceptor (PC-B2: employing β-type oxytitanium phthalocyanine) was mounted on a laser printer Docuprint P1201, manufactured by Xerox, and toner TA1 or TB1 was put into the development tank, whereupon fine line images were formed in a longitudinal direction and in a transverse direction of two dot on and two dot off at an exposure density of 600 dpi. The image analysis was carried out in the same manner as the above Example Al to obtain the results as shown in FIG. 5 (the results of the image analysis of the fine images drawn in the longitudinal direction) and FIG. 6 (the results of the image analysis of the fine images drawn in the transverse direction).

From these results, it is evident that a similar resolution is obtainable in both the longitudinal and transverse directions when either toner TA1 or TB1 is employed.

Namely, the results show that in a case where a highly sensitive photoreceptor containing Y-type oxytitanium phthalocyanine is employed, when a toner having a small particle diameter and a sharp particle size distribution, is employed, images can be reproduced with a high resolution, and the performance of the highly sensitive photoreceptor can be obtained particularly excellently.

### COMPARATIVE EXAMPLE B2

The image-forming was carried out in the same manner as in Example 1 except that in Comparative Example B1, as the toner, genuine kneaded/pulverized yellow toner of N4-612 (TB2) was employed, instead of the above-described cyan toner (TB1), whereby results similar to Comparative Example B1 were obtained.

Here, the volume average particle diameter (Dv) of TB2 was 9.18 μm, Dv/Dn=1.25, the 50% circularity was 0.93, and the proportion of the number of particles having particle diameters of from 0.6 to 2.12 μm was 13.7%.

### COMPARATIVE EXAMPLE B3

The image-forming was carried out in the same manner as in Example 1 except that in Comparative Example B1, as the toner, genuine kneaded/pulverized magenta toner (TB3) of N4-612 (TB3) was employed, instead of the above-described cyan toner (TB1), whereby results similar to Comparative Example B1 were obtained.

Here, the volume average particle diameter (Dv) of TB3 was 9.16 μm, Dv/Dn=1.32, the 50% circularity was 0.93, and the proportion of the number of particles having particle diameters of from 0.6 to 2.12 μm was 15.8%.

### EXAMPLE A2

The image-forming is carried out in the same manner as in Example A1 except that in Example A1, as the toner, an yellow toner (TA2) is employed, instead of the above-described cyan toner (TA1), whereby an image of a resolution equal to Example A1 can be obtained.

### EXAMPLE A3

The image-forming is carried out in the same manner as in Example A1 except that in Example A1, as the toner, a magenta toner (TA3) is employed, instead of the above-described cyan toner (TA1), whereby an image of a resolution equal to Example A1 is obtainable.

### EXAMPLE A5

The image-forming is carried out in the same manner as in Example A1 except that in Example A1, photoreceptor (PC-A2) is employed, instead of the photoreceptor (PC-A1), whereby an image of a resolution equal to Example A1 is obtainable.

### EXAMPLE A6

The image-forming is carried out in the same manner as in Example A1 except that in Example A1, photoreceptor (PC-A3) is employed, instead of the photoreceptor (PC-A1), whereby an image of a resolution equal to Example A1 is obtainable.

### EXAMPLE A7

The image-forming is carried out in the same manner as in Example A1 except that in Example A1, photoreceptor (PC-A4) is employed, instead of the photoreceptor (PC-A1), whereby an image of a resolution equal to Example A1 is obtainable.

### EXAMPLE A8

The image-forming is carried out in the same manner as in Example A1 except that in Example A1, photoreceptor (PC-A5) is employed, instead of the photoreceptor (PC-A1), whereby an image of a resolution equal to Example A1 is obtainable.

### EXAMPLES A9 To A14, AND COMPARATIVE EXAMPLE B4 AND B5

Preparation of Toners for Development-4 (TA-4 to TA9)

Preparation of Colorant Dispersions

i) Colorant Dispersion A

To 50 g of C.I. pigment red 48:2, 150 g of demineralized water and 7.6 g of an alkylbenzene sulfonate were added and subjected to dispersion treatment by a sand grinder mill for 6 hours to obtain a colorant dispersion having an average particle diameter of 0.20 μm.

ii) Colorant Dispersion B

To 60 g of C.I. pigment blue 15:3, 130 g of demineralized water and 10 g of a polyoxyethylene alkyl phenyl ether were added and subjected to dispersion treatment by a sand grinder mill for 6 hours to obtain colorant dispersion B having an average particle diameter of 0.15 μm.

iii) Colorant Dispersion C

To 40 g of C.I. pigment yellow 74, 146 g of demineralized water and 14 g of a polyoxyethylene alkyl phenyl ether were added and subjected to dispersion treatment by a sand grinder mill for 6 hours to obtain colorant dispersion C having an average particle diameter of 0.30 μm.

iv) Colorant Dispersion D

To 40 g of carbon black (MA100, manufactured by Mitsubishi Chemical Corporation), 146 g of demineralized water and 14 g of a polyoxyethylene alkyl phenyl ether were added and subjected to dispersion treatment by a sand grinder mill for 6 hours to obtain colorant dispersion D having an average particle diameter of 0.30 μm.

Preparation of Polymer Emulsion

Into a reactor, 2.2 kg of an ester wax emulsion having a solid content of 30% and 26 kg of demineralized water were charged, and the temperature was raised to 90° C., whereupon 6 g of dodecylbenzene sulfonate, 5 kg of styrene, 1.3 kg of n-butyl acrylate, 186 g of acrylic acid, 25 g of divinylbenzene, 31 g of trichlorobromomethane, 656 g of a 8% hydrogen peroxide aqueous solution and 656 g of a 8% ascorbic acid aqueous solution, were added. The reaction was continued at 90° C. for 7 hours to obtain an emulsion comprising a styrene acryl polymer (polymer primary particle dispersion).

Preparation of Charge Control Agent Dispersion

To 40 g of 4,4′-methylenebis[2-[N-(4-chlorophenyl)amide]-3-hydroxynaphthalene], 160 g of deionized water and 8 g of an alkylnaphthalene sulfonate as a dispersant, were added and subjected to dispersion treatment by a sand grinder mill for 2 hours to obtain a charge control agent dispersion.

Preparation of Toners

a) Toner (TA4)

To 300 g of the polymer emulsion, 19 g of the colorant dispersion A and 1.8 g of the charge control agent dispersion were mixed and stirred. While continuing the stirring, 79.4 g of 0.5% Al₂(SO₄)₃ was added thereto, and the temperature was raised to 60° C. from 25° C. over a period of 2 hours, whereupon stirring was continued. 2 g of dodecylbenzene sulfonate was added thereto, and the temperature was raised to 98° C., whereupon stirring was continued for 6 hours. The obtained particles were repeatedly subjected to suction filtration and washing with water and air-dried to obtain 60 g of a magenta toner.

The particle diameter of the obtained particles was measured by the Coulter Counter, whereby the volume average diameter was 7.6 μm, and the number average diameter was 6.7 μm. The value of volume average particle diameter/number average particle diameter was 1.13, and the particle size distribution was excellent. Further, the circularity and the proportion of the number of particles of from 0.6 to 2.12 μm were measured by means of FPIA-2000, whereby the 50% circularity was 0.99, and the proportion of the number of particles of from 0.6 to 2.12 μm was 6%.

To 100 parts of the toner, 1 part of silica having hydrophobic surface treatment applied, was added and mixed to obtain a toner for development (this is referred to as TA4).

b) Toner (TA5)

The production was carried out in the same manner as for toner (TA4) except that the colorant dispersion B was used instead of the colorant dispersion A used for the above toner (TA4), whereby 57 g of a cyan toner having a volume average diameter of 7.3 μm and a number average diameter of 6.3 μm was obtained. Here, the value of volume average diameter/number average diameter was 1.16. Further, the 50% circularity was 0.99, and the proportion of the number of particles of from 0.6 to 2.12 μm was 4%.

Additive treatment was carried out in the same manner as for toner (TA4) to obtain a toner for development (this is referred to as TA5).

c) Toner (TA6)

The production was carried out in the same manner as for toner (TA4) except that the colorant dispersion C was used instead of the colorant dispersion A used for the above toner (TA4), whereby 57 g of a yellow toner having a volume average diameter of 7.5 μm and a number average diameter of 6.3 μm was obtained. Here, the value of volume average diameter/number average diameter was 1.19. Further, the 50% circularity was 0.99, and the proportion of the number of particles of from 0.6 to 2.12 μm was 3%.

Additive treatment was carried out in the same is manner as for toner (TA4) to obtain a toner for development (this is referred to as TA6).

d) Toner (TA7)

The production was carried out in the same manner as for toner (TA4) except that the colorant dispersion D was used instead of the colorant dispersion A used for the above toner (TA4), whereby 57 g of a black toner having a volume average diameter of 7.5 μm and a number average diameter of 6.2 μm was obtained. Here, the value of volume average diameter/number average diameter was 1.21. Further, the 50% circularity was 0.98, and the proportion of the number of particles of from 0.6 to 2.12 μm was 4%.

Additive treatment was carried out in the same manner as for toner (TA4) to obtain a toner for development (this is referred to as TA7).

e) Toner (TA8)

The production was carried out in the same manner as for toner (TA4) except that in the production of the above toner (TA4) the stirring time at 98° C. was changed from 6 hours to 1 hour, whereby 59 g of a magenta toner having a volume average diameter of 7.3 μm and a number average diameter of 6.4 μm was obtained. Here, the value of volume average diameter/number average diameter was 1.15. Further, the 50% circularity was 0.93, and the proportion of the number of particles of from 0.6 to 2.12 μm was 7%.

Additive treatment was carried out in the same manner as for toner (TA4) to obtain a toner for development (this is referred to as TA8).

f) Toner (TA9)

The production was carried out in the same manner as for toner (TA4) except that in the production of the above toner (TA4), the temperature raising time from 25° C. to 60° C. was changed from 2 hours to 30 minutes, whereby 60 g of a magenta toner having a volume average particle diameter of 7.5 μm and a number average particle diameter of 6.2 μm was obtained. Here, the value of volume average diameter/number average diameter was 1.21. Further, the 50% circularity was 0.98, and the proportion of the number of particles of from 0.6 to 2.12 μm was 16%.

Additive treatment was carried out in the same manner as for toner (TA4) to obtain a toner for development (this is referred to as TA9).

g) Toner (TB4) (Comparative Toner)

To 94 parts of a polyester resin (Tg=60° C., 1% crosslinking), 10 parts of the master batch of the above-described polyester resin containing 40% of phthalocyanine blue 15:3, and 1 part of 4,4′-methylenebis[4-[N-(4-chlorophenyl)amide]-3-hydroxynaphthalene] as a charge control agent were melted and kneaded, followed by pulverization and classification. Here, the volume average diameter of the obtained toner was 7.8 μm, and the number average diameter was 5.8 μm. Further, the value of volume average diameter/number average diameter was 1.34. To 100 parts of this toner, 1 part of silica having hydrophobic surface treatment applied, was added and mixed to obtain a comparative toner for development. (This is referred to TB4.)

Preparation Example of Photoreceptor-6 (Comparative Photoreceptor: Using β-type TiOPc)

The production was carried out in the same manner as in Preparation Example of photoreceptor-4 except that in Preparation Example of photoreceptor-4, as the oxytitanium phthalocyanine, β-type was used in stead of the Y-type.

This is referred to as photoreceptor “PC-B1”.

Preparation Example of Photoreceptor-7 (Comparative Photoreceptor: Using β-type TiOPc)

The photoreceptor was prepared in the same manner as in Preparation Example of photoreceptor-6 except that in Preparation Example of photoreceptor-6, as an aluminum substrate, one having a diameter of 30 mm and a length of 243 mm was employed.

This is referred to as photoreceptor “PC-B2”.

Evaluation Method

The toner (TA4 to TA9) and the photoreceptor (PC-A1 or PC-B1) obtained as described above, were mounted on Color Pagepresto N4-612II, manufactured by Casio K.K., and image-forming was carried out at an exposure density of 600 dpi, whereupon evaluation was carried out with respect to the following items. The results are shown in Table 2.

Gradation

A print roller having an image mode capable of distinguishing the image density in 10 grades by the area ratio of halftone dots, was connected, and evaluation was made to what grade the printed image can be distinguished. The larger the distinguishable grade, the higher the gradation.

Resolution-4

Exposure was carried out to draw 6, 9 and 12 longitudinal lines per 1 mm in equal distances as printed images, followed by image forming, whereupon evaluation was made visually to determine how many longitudinal lines per 1 mm can be distinguished. The larger the number of distinguishable lines, the higher the resolution.

Resolution-5

The resolution was evaluated by the reproducibility of isolated dots having a diameter of 50 μm on the printed images.

A: Excellent reproducibility

B: Good reproducibility

C: Inadequate resolution

TABLE 2

| | | Photo- | Grada- | Resolu- | Resolu- |
|---|---|---|---|---|---|
| | Toner | receptor | tion | tion-4 | tion-5 |
| Example | TA4 | PC-A2 | 9 grade | 12 lines | A |
| A9 | | | | | |
| Example | TA5 | PC-A2 | 9 grade | 12 lines | A |
| A10 | | | | | |
| Example | TA6 | PC-A2 | 9 grade | 12 lines | A |
| A11 | | | | | |
| Example | TA7 | PC-A2 | 9 grade | 12 lines | A |
| A12 | | | | | |
| Example | TA8 | PC-A2 | 9 grade | 12 lines | A |
| A13 | | | | | |
| Example | TA9 | PC-A2 | 9 grade | 12 lines | A |
| A14 | | | | | |
| Compara- | TB4 | PC-A2 | 9 grade | 12 lines | B |
| tive | | | | | |
| Example | | | | | |
| B4 | | | | | |
| Compara- | TA1 | PC-B1 | 8 grade | 12 lines | B |
| tive | | | | | |
| Example | | | | | |
| B5 | | | | | |

As described in the foregoing, according to the present invention, formation of images with high gradation and high resolution has been accomplished by using the above-described specific titanyl phthalocyanine for a photoreceptor in combination with the specific particle size distribution of the toner.

What is claimed is:

1. An image-forming apparatus comprising at least a photoreceptor, a toner and an exposure device, wherein the photoreceptor has a photosensitive layer containing oxytitanium phthalocyanine having a distinct diffraction peak at a Bragg angle (2θ±0.2) of 27.3° in the X-ray diffraction by CuKα-ray, and the toner has a volume average particle diameter (Dv) of from 3 to 8 μm and satisfies a relation of 1.0≦Dv/Dn≦1.3 where Dv is the volume average particle diameter and Dn is the number average particle diameter.

2. The image-forming apparatus according to claim 1, which has a toner cartridge accommodating the toner having a volume average particle diameter (Dv) of from 3 to 8 μm and satisfying a relation of 1.0≦Dv/Dn≦1.3 where Dv is the volume average particle diameter and Dn is the number average particle diameter and a photoreceptor cartridge accommodating the photoreceptor having a photosensitive layer containing oxytitanium phthalocyanine having a distinct diffraction peak at a Bragg angle (2θ±0.2) of 27.3° in the X-ray diffraction by CuKα-ray.

3. The image-forming apparatus according to claim 1, which has an electrophotographic cartridge accommodating both the toner having a volume average particle diameter (Dv) of from 3 to 8 μm and satisfying a relation of 1.0≦Dv/Dn≦1.3 where Dv is the volume average particle diameter and Dn is the number average particle diameter and the photoreceptor having a photosensitive layer containing oxytitanium phthalocyanine having a distinct diffraction peak at a Bragg angle (2θ±0.2) of 27.3° in the X-ray diffraction by CuKα-ray.

4. The image-forming apparatus according to claim 1, wherein the photosensitive layer comprises a charge generation layer and a charge transport layer laminated on each other.

5. The image-forming apparatus according to claim 1, wherein the toner comprises at least a binder resin and a colorant and is produced by a wet polymerization method.

6. The image-forming apparatus according to claim 5, wherein the toner contains from 1 to 40 wt % of wax.

7. The image-forming apparatus according to claim 6, wherein the wax has a melting point of from 30 to 100° C.

8. The image-forming apparatus according to claim 6, wherein the wax contains a fatty acid alkyl ester having from 10 to 30 carbon atoms.

9. The image-forming apparatus according to claim 6, wherein the wax contains a fatty acid ester of a polyhydric alcohol having from 15 to 50 carbon atoms.

10. The image-forming apparatus according to claim 1, wherein the toner is obtained via a step of agglomerating at least primary particles of a polymer and colorant particles to obtain particle agglomerates.

11. The image-forming apparatus according to claim 10, wherein the toner is obtained via a step of attaching fine particles of a resin containing no wax to the particle agglomerates.

12. The image-forming apparatus according to claim 10, wherein the toner is obtained via a step of maintaining the particle agglomerates within a temperature range of from Tg+20° C. to Tg+80° C., where Tg is a glass transition temperature of primary particles of the polymer, for at least one hour.

13. The image-forming apparatus according to claim 11, wherein the toner is obtained via a step of attaching fine particles of a resin containing no wax to the particle agglomerates, and maintaining the particle agglomerates within a temperature range of from Tg+20° C. to Tg+80° C., where Tg is a glass transition temperature of primary particles of the polymer, for at least one hour.

14. The image-forming apparatus according to claim 10, wherein the primary particles of a polymer internally contains wax.

15. The image-forming apparatus according to claim 14, wherein the primary particles of a polymer are ones obtained by polymerizing a monomer in the presence of fine particles of wax emulsified and dispersed.

16. The image-forming apparatus according to claim 1, wherein the volume average particle diameter (Dv) of the toner is from 4 to 8 μm, and the measured value (the number) of particles having particle diameters of from 0.6 to 2.12 μm is at most 15% of the total number of particles.

17. The image-forming apparatus according to claim 1, wherein the 50% circularity corresponding to the cumulative particle size value at 50% of the value obtained by the following formula (I), of the toner, is from 0.9 to 1:
Circularity=Peripheral length of a circle having the same area as the area of the projected image of a particle/peripheral length of the projected image of the particle (I)

18. The image-forming apparatus according to claim 1, wherein the photoreceptor has at least a charge generation layer and a charge transport layer in this order on a cylindrical conductive substrate.

19. The image-forming apparatus according to claim 18, wherein the charge transport layer comprises at least a charge transport agent and a binder resin, and contains, as the charge transport agent, a compound of the formula (III): 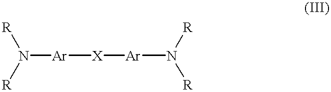
wherein X is a bivalent residue which may have a substituent, Ar is an aryl group which may have a substituent, and R is an aryl, alkyl, condensed polycyclic or heterocyclic group which may have a substituent.

20. The image-forming apparatus according to claim 18, wherein the charge transport layer comprises at least a charge transport agent and a binder resin, and contains, as the charge transport agent, a compound of the formula (IV): 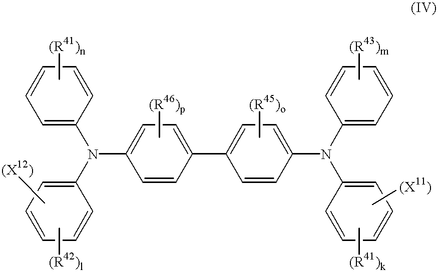
wherein each of R⁴¹, R⁴², R⁴³, R⁴⁴, R⁴⁵ and R⁴⁶ which may be the same or different, is a hydrogen atom, a halogen atom, an alkyl group which may have a substituent, an alkoxy group which may have a substituent, an aryl group which may have a substituent, or a substituted amino group, each of k, l, m, n, o and p is an integer of from 0 to 4, provided that when it is an integer of 2 or more, the plurality of R⁴¹, R⁴², R⁴³, R⁴⁴, R⁴⁵ or R⁴⁶ may be the same or different, X¹¹ represents the following formula (IV-a), and X¹² represents the following formula (IV-b): 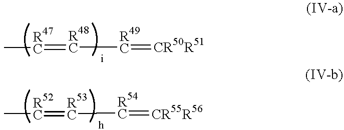
wherein i is an integer of from 0 to 2, h is an integer of from 0 to 2, each of R⁴⁷, R⁴⁸, R⁴⁹, R⁵⁰, R⁵¹, R⁵², R⁵³, R⁵⁴, R⁵⁵ and R⁵⁶ which may be the same or different, is a hydrogen atom, an alkyl group which may have a substituent, an alkoxy group which may have a substituent, an aryl group which may have a substituent, or a heterocyclic group which may have a substituent, and the pair of R⁵⁰ and R⁵¹ or the pair of R⁵⁵ and R⁵⁶ may be condensed to form a carbon ring group or a heterocyclic group, provided that when one of the pair of R⁵⁰ and R⁵¹ or the pair of R⁵⁵ and R⁵⁶, is a hydrogen atom or an alkyl group, the other is an aryl group or a heterocyclic group; when i=2, the plurality of R⁴⁷ and R⁴⁸ may respectively be the same or different; and when h=2, the plurality of R⁵² and R⁵³ may respectively be the same or different; and X¹¹ and X¹² may be the same or different.

21. The image-forming apparatus according to claim 18, wherein the charge transport layer comprises at least a charge transport agent and a binder resin, and contains, as the charge transport agent, a compound of the formula (V): 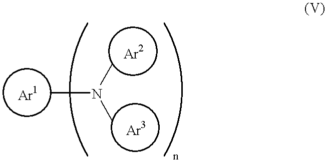
wherein Ar¹ is a benzene ring which may have a substituent, a naphthalene group which may have a substituent, or a biphenyl group which may have a substituent, each of Ar² and Ar³ which are independent of each other, is an aromatic ring which may have a substituent, and n is 1 or 2.

22. The image-forming apparatus according to claim 18, wherein the charge transport layer comprises at least a charge transport agent and a binder resin, and contains, as the charge transport agent, a compound of the formula (VI): 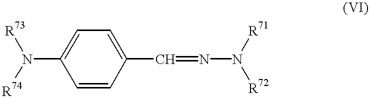
wherein each of R⁷¹, R⁷², R⁷³ and R⁷⁴ which are independent of one another, is an alkyl group which may have a substituent, an aryl group which may have a substituent, or an aralkyl group which may have a substituent.

23. The image-forming apparatus according to claim 18, wherein the binder resin in the charge transport layer contains a polycarbonate.

24. The image-forming apparatus according to claim 23, wherein the polycarbonate resin contains a structural unit of the following formula (XIII): 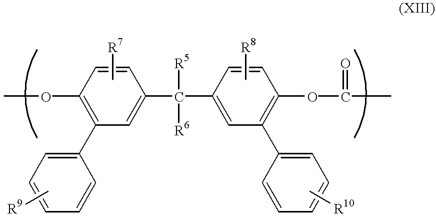
wherein each of R⁵ and R⁶ which are independent of each other, is a hydrogen atom, an alkyl group which may have a substituent, or a phenyl group, or R⁵ and R⁶ may bond to each other to have a cyclic structure, each of R⁷ and R⁸ which are independent of each other, is a hydrogen atom, an alkyl group which may have a substituent, or an aralkyl group, and each of R⁹ and R¹⁰ which are independent of each other, is a hydrogen atom or an alkyl group which may have a substituent.

25. The image-forming apparatus according to claim 23, wherein the polycarbonate resin contains a structural unit of the following formula (XIV): 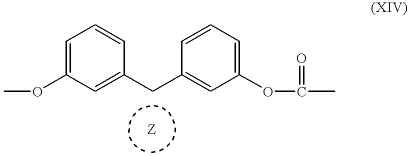
wherein Z is a C₅₋₈ aliphatic hydrocarbon ring which may have a substituent.

26. The image-forming apparatus according to claim 23, wherein the polycarbonate resin contains a structural unit of the following formula (XV): 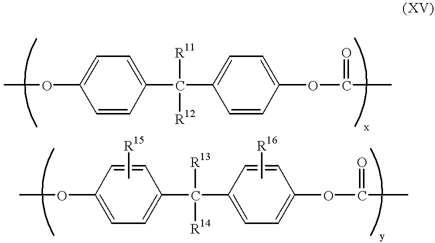
wherein each of R¹¹ and R¹² which are independent of each other, is a hydrogen atom or an alkyl group which may have a substituent, each of R¹³ and R¹⁴ which is independent of each other, is a hydrogen atom or an alkyl group which may have a substituent, or R¹³ and R¹⁴ may be bonded to each other to have a cyclic structure, each of R¹⁵ and R¹⁶ which are independent of each other, is a hydrogen atom or an alkyl group which may have a substituent, provided that all of R¹¹ and R¹⁴ are not the same groups, and both R¹⁵ and R¹⁶ are not hydrogen atoms, and x:y=1:9 to 9:1.

27. The image-forming apparatus according to claim 18, wherein the binder resin of the charge transport layer contains a polyarylate.

28. The image-forming apparatus according to claim 27, wherein the polyarylate resin contains a structural unit of the following formula (XII): 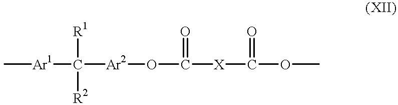
wherein each of Ar¹ and Ar² which are independent of each other, is a benzene ring which may have a substituent, X is a bivalent aliphatic hydrocarbon group which may have a substituent, a benzene ring which may have a substituent, a naphthalene group which may have a substituent, or a biphenyl group which may have a substituent, each of R¹ and R² which are independent of each other, is an aryl group which may have a substituent, an acyloxy group which may have a substituent, or an arylsulfoxy group which may have a substituent, or R¹ and R² may be bonded to each other to form a cyclic structure.

29. The image-forming apparatus according to claim 18, wherein the binder resin of the charge generation layer contains a polyvinyl butyral.

30. The image-forming apparatus according to claim 18, wherein the photoreceptor has an interlayer between the conductive substrate and the charge generation layer.

31. The image-forming apparatus according to claim 30, which has an alumite layer as the interlayer.

32. The image-forming apparatus according to claim 30, which has an undercoat layer as the interlayer, wherein the binder resin of the undercoat layer contains a polyamide.

33. The image-forming apparatus according to claim 30, which has both an alumite layer and an undercoat layer as the interlayer.

34. The image-forming apparatus according to claim 1, wherein the photoreceptor is in the form of a drum having an inner diameter of from 10 to 40 mm.

35. The image-forming apparatus according to claim 1, wherein the exposure device is one which carries out a digital image exposure with a recording dot density of at least 600 dots/inch to the photoreceptor.

36. The image-forming apparatus according to claim 1, wherein the exposure device emits a laser beam having a wavelength within a range of from 500 to 850 nm.

37. The image-forming apparatus according to claim 1, which is provided with at least four color toners of yellow, magenta, cyan and black.

38. The image-forming apparatus according to claim 37, wherein said at least four color toners of yellow, magenta, cyan and black are, respectively, accommodated in toner cartridges, which are arranged in a tandem form.

39. An image-forming method employing an image-forming apparatus comprising at least a photoreceptor, an exposure device and a toner, which comprises subjecting a photoreceptor having a photosensitive layer having a charge generation layer containing oxytitanium phthalocyanine having a distinct diffraction peak at a Bragg angle (2θ±0.2) of 27.3° in the X-ray diffraction by CuKα-ray and a charge transport layer laminated, to digital image exposure by said exposure device, to form an electrostatic latent image on the photoreceptor, and developing the electrostatic latent image, wherein a toner having a volume average particle diameter (Dv) of from 3 to 8 μm and satisfying a relation of 1.0≦Dv/Dn≦1.3 where Dv is the volume average particle diameter and Dn is the number average particle diameter, is used for the development.

40. The image-forming method according to claim 39, wherein digital image exposure with a recording dot density of at least 600 dots/inch, is carried out by the exposure device.

41. An electrophotographic cartridge accommodating both a toner having a volume average particle diameter (Dv) of from 3 to 8 μm and satisfying a relation of 1.0≦Dv/Dn≦1.3 where Dv is the volume average particle diameter and Dn is the number average particle diameter and a photoreceptor having a charge generation layer containing oxytitanium phthalocyanine having a distinct diffraction peak at a Bragg angle (2θ±0.2) of 27.3° in the X-ray diffraction by CuKα-ray and a charge transport layer laminated.

42. The image-forming apparatus according to claim 1, which is loaded with an electrophotographic cartridge accommodating both a toner having a volume average particle diameter (Dv) of from 3 to 8 μm and satisfying a relation of 1.0≦Dv/Dn≦1.3 where Dv is the volume average particle diameter and Dn is the number average particle diameter and a photoreceptor having a charge generation layer containing oxytitanium phthalocyanine having a distinct diffraction peak at a Bragg angle (2θ±0.2) of 27.3° in the X-ray diffraction by CuKα-ray and a charge transport layer laminated.
